(19) United States
(12) Patent Application Publication
(10) Pub. No.: US 2023/0009297 A1
(43) Pub. Date: Jan. 12, 2023

(54) ALL-SOLID SECONDARY BATTERY AND METHOD OF MANUFACTURING ALL-SOLID SECONDARY BATTERY

(71) Applicant: Samsung Electronics Co., Ltd., Hwaseong-si (KR)

(72) Inventors: Jusik Kim, Hwaseong-si (KR); Victor ROEV, Hwaseong-si (KR); Myungjin Lee, Seoul (KR)

(21) Appl. No.: 17/671,740

(22) Filed: Feb. 15, 2022

(30) Foreign Application Priority Data
Jul. 8, 2021 (KR) 10-2021-0089946
Dec. 7, 2021 (KR) 10-2021-0174021

(51) Int. Cl. H01M 10/0585; H01M 10/0525; H01M 4/36; H01M 4/38; H01M 4/587; H01M 4/62

(52) U.S. Cl. CPC H01M 10/0585; H01M 4/38; H01M 4/62; H01M 4/364; H01M 4/366; H01M 4/587; H01M 10/0525; H01M 2004/021

(57) ABSTRACT

An all-solid secondary battery includes: a cathode layer; an anode layer; and a solid electrolyte between the cathode layer and the anode layer, wherein the anode layer includes an anode current collector and a first anode active material layer on the anode current collector, the first anode active material layer includes a modified ordered mesoporous carbon, and an oxygen content of a surface of the modified ordered mesoporous carbon is about 3 atomic percent to about 10 atomic percent, based on a total content of the surface, when determined by an X-ray photoelectron spectroscopy spectrum of the surface of the modified ordered mesoporous carbon.

### CROSS-REFERENCE TO RELATED APPLICATION

This application is based on and claims priority to Korean Patent Application No. 10-2021-0089946, filed on Jul. 8, 2021, and Korean Patent Application No. 10-2021-0174021, filed on Dec. 7, 2021, in the Korean Intellectual Property Office, and the benefits accruing therefrom under 35 U.S.C. §119, the content of which is incorporated by reference herein in its entirety.

### BACKGROUND

### 1. Field

The present disclosure relates to an all-solid secondary battery and a method of manufacturing the same.

### 2. Description of the Related Art

Recently, batteries having high energy density and high safety have been actively developed in accordance with industrial requirements. For example, lithium-ion batteries have been commercially available in the automotive field as well as in the fields of information-associated equipment and communication equipment..

A currently commercially available lithium-ion battery uses a liquid electrolyte including a flammable organic solvent, and thus there is a risk of overheating and fire when a short-circuit occurs. Accordingly, an all-solid battery using a solid electrolyte instead of such a liquid electrolyte has been suggested.

An all-solid secondary battery could significantly reduce the risk of fire or explosion even if a short-circuit occurs. Accordingly, an all-solid secondary battery may have increased safety as compared with a lithium-ion battery including a liquid electrolyte.

In an all-solid battery using lithium as an anode active material, lithium deposited on an anode layer by charging may be used as the active material. In such an all-solid secondary battery, if the lithium deposited on the anode layer grows into the solid electrolyte layer, a short-circuit in the battery may occur, and also there can be a reduction in battery capacity. Thus there remains a need for improved battery materials.

### SUMMARY

One or more embodiments include an all-solid secondary battery having increased discharge capacity, and improved high-rate characteristics and lifetime characteristics.

Additional aspects will be set forth in part in the description which follows and, in part, will be apparent from the description, or may be learned by practice of the presented embodiments of the disclosure.

According to one or more embodiments, provided is an all-solid secondary battery including: a cathode layer; an anode layer; and a solid electrolyte layer between the cathode layer and the anode layer, wherein the anode layer includes an anode current collector and a first anode active material layer on the anode current collector, the first anode active material layer includes a modified ordered mesoporous carbon, and an oxygen content of a surface of the modified ordered mesoporous carbon is about 3 atomic percent to about 10 atomic percent, based on a total content of the surface, when determined by X-ray photoelectron spectroscopy (XPS) spectrum of a surface of the modified ordered mesoporous carbon.

According to one or more embodiments, provided is a method of manufacturing the all-solid secondary battery, the method including: providing an ordered mesoporous carbon optionally comprising a precursor of a first metal oxide, a precursor of a first metalloid oxide, or a combination thereof; thermally treating the ordered mesoporous carbon in an oxidizing atmosphere to prepare a modified ordered mesoporous carbon; disposing the modified ordered mesoporous carbon in the form of a layer to prepare an anode layer; and stacking a solid electrolyte between the anode layer and a cathode layer, wherein an oxygen content of a surface of the modified ordered mesoporous carbon is about 3 atomic percent to about 10 atomic percent, based on a total content of the surface, when determined by X-ray photoelectron spectroscopy of the surface of the modified ordered mesoporous carbon.

An anode for an all-solid secondary battery includes an anode current collector, and an anode active material layer on the anode current collector, wherein the anode active material layer includes a modified ordered mesoporous carbon, and an oxygen content of a surface of the modified ordered mesoporous carbon is about 3 atomic percent to about 10 atomic percent, based on a total content of the surface, when determined by X-ray photoelectron spectroscopy of a surface of the modified ordered mesoporous carbon.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of an embodiment of an all-solid secondary battery;

FIG. 2 is a cross-sectional view of another embodiment of an all-solid secondary battery;

FIGS. 3A to 3C are transmission electron microscope (TEM) images of a modified ordered mesoporous carbon (modified OMC) used in Example 1;

FIGS. 4A to 4C are TEM images of an ordered mesoporous carbon used in Comparative Example 1;

FIG. 5A is a graph of intensity (arbitrary units, a.u.) versus binding energy (electronvolt, eV) illustrating X-ray photoelectron spectroscopy (XPS) spectra of the modified ordered mesoporous carbons used in Examples 1 and 2 and the ordered mesoporous carbon used in Comparative Example 1;

FIG. 5B is a graph of intensity (arbitrary units, a.u.) versus binding energy (electronvolt, eV) illustrating an XPS spectrum of the modified ordered mesoporous carbon used in Example 1;

FIG. 6A is a graph of intensity (arbitrary units, a.u.) versus diffraction angle (degrees 2θ) illustrating small-angle X-ray diffraction (XRD) spectra of the modified ordered mesoporous carbons used in Examples 1 and 2 and the ordered mesoporous carbon used in Comparative Example 1; and

FIG. 6B is a graph of intensity (arbitrary units, a.u.) versus diffraction angle (degrees 2θ) illustrating wide-angle XRD spectra of the modified ordered mesoporous carbon used in Examples 1 and 2 and the ordered mesoporous carbon used in Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain various aspects. As used herein, the term “and/or” includes any and all combinations of one or more of the associated listed items. Expressions such as “at least one of,” when preceding a list of elements, modify the entire list of elements and do not modify the individual elements of the list.

In an all-solid secondary battery including, as a solid electrolyte, an oxide-based solid electrolyte, an interface is formed between the solid electrolyte and an anode layer. While not wanting to be bound by theory, it is understood that lithium metal is locally deposited at the interface between the solid electrolyte layer and the anode layer, and the deposited lithium can grow and consequently pass through the solid electrolyte layer, and thus may cause a short-circuit of the battery or deteriorate cycle characteristics. In addition, other anode active material, such as graphite or carbon black, included in the anode layer may not provide a large contact area between the solid electrolyte layer and the anode layer, or the diffusion rate of lithium passing through the anode active material in the anode layer may be slow. In an all-solid-state secondary battery having an anode layer including such an anode active material, a short-circuit can occur or cycle characteristics may deteriorate.

Therefore, it is desired to provide an all-solid-state secondary battery in which a short-circuit is prevented during charging and discharging, a discharge capacity is increased, and high-rate characteristics and lifespan characteristics are improved.

The present disclosure will now be described more fully with reference to the accompanying drawings, in which example embodiments are shown. The present disclosure may, however, be embodied in many different forms, should not be construed as being limited to the embodiments set forth herein, and should be construed as including all modifications, equivalents, and alternatives within the scope of the present disclosure; rather, these embodiments are provided so that this disclosure will be thorough and complete, and will fully convey the effects and features of the present disclosure and ways to implement the disclosure to those skilled in the art.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the slash “/” or the term “and/or” includes any and all combinations of one or more of the associated listed items.

In the drawings, the size or thickness of each layer, region, or element are arbitrarily exaggerated or reduced for better understanding or ease of description, and thus the present disclosure is not limited thereto. Throughout the written description and drawings, like reference numbers and labels will be used to denote like or similar elements. It will also be understood that when an element such as a layer, a film, a region or a component is referred to as being “on” another layer or element, it can be “directly on” the other layer or element, or intervening layers, regions, or components may also be present. In contrast, when an element is referred to as being “directly on” another element, there are no intervening elements present. Although the terms “first”, “second”, etc., may be used herein to describe various elements, components, regions, and/or layers, these elements, components, regions, and/or layers should not be limited by these terms. These terms are used only to distinguish one component from another, not for purposes of limitation. In the following description and drawings, constituent elements having substantially the same functional constitutions are assigned like reference numerals, and overlapping descriptions will be omitted.

Spatially relative terms, such as “beneath,” “below,” “lower,” “above,” “upper” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the term “metal” refers to metallic or metalloid elements as defined in the Periodic Table of Elements Groups 1 to 17, including the lanthanide elements and the actinide elements.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, example embodiments of an all-solid secondary battery and a method of manufacturing an all-solid secondary battery will be described in greater detail.

### All-Solid Secondary Battery

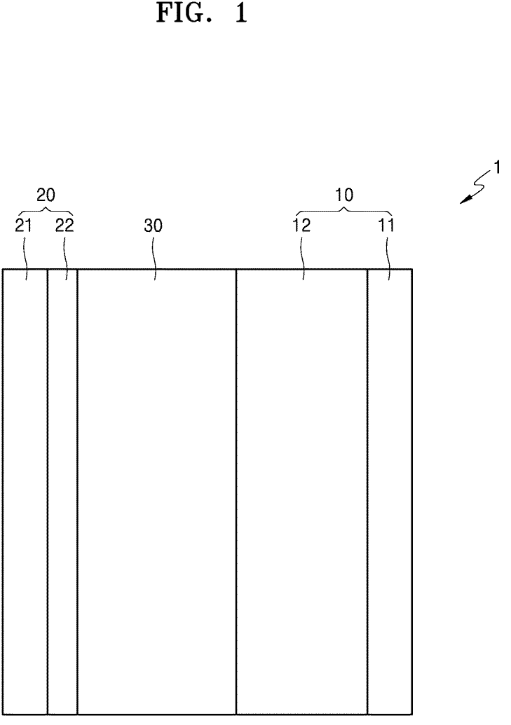

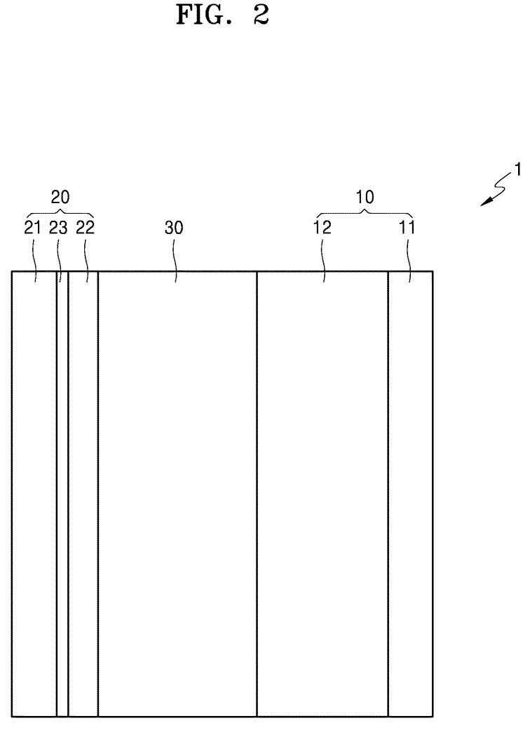

Referring to FIGS. 1 and 2, an all-solid secondary battery 1 includes a cathode layer 10, an anode layer 20, and a solid electrolyte layer 30 between the cathode layer 10 and the anode layer 20, wherein the anode layer 20 includes an anode current collector 21 and a first anode active material layer 22, and the first anode active material layer 22 includes a modified ordered mesoporous carbon, and an oxygen content on a surface of the modified ordered mesoporous carbon is about 3 atomic percent (at%) to about 10 at%, based on a total content of the surface, when determined by X-ray photoelectron spectroscopy (XPS) analysis of a surface of the modified ordered mesoporous carbon. The oxygen content may be, for example, about 4 at% to about 10 at%, or about 5 at% to about 10 at%, based on a total content of the surface.

### Anode Layer

Referring to FIGS. 1 and 2, the first anode active material layer 22 includes a modified ordered mesoporous carbon, and the oxygen content on the surface of the modified ordered mesoporous carbon is about 3 at% to about 10 at%, based on a total content of the surface. The all-solid secondary battery 1 having the anode layer including such modified ordered mesoporous carbon may provide improved discharge capacity, high-rate characteristics and lifespan characteristics. When the oxygen content on the surface of the modified ordered mesoporous carbon is too low, the lithophilicity (i.e., affinity with lithium) of the modified ordered mesoporous carbon may be reduced. When the oxygen content on the surface of the modified ordered mesoporous carbon is too high, the surface of the modified ordered mesoporous carbon may substantially have insulating properties, and the electronic conductivity of the modified ordered mesoporous carbon may be reduced. The modified ordered mesoporous carbon may be, for example, oxygenated ordered mesoporous carbon or lithophilic ordered mesoporous carbon. For example, a commercially available ordered mesoporous carbon, such as CMK-3, CMK-5, CMK-8, FDU-15, or FDU-16, may be used as a starting material.

The modified ordered mesoporous carbon has an oxygen content within the ranges described above, and thus may have improved lithophilicity. For example, the oxygen on the surface of the modified ordered mesoporous carbon may react with lithium ions to reduce the nucleation energy of the lithium ions, and thus may facilitate lithium metal formation. In addition, lithium may more rapidly and uniformly diffuse through the surface of the modified ordered mesoporous carbon, for example, through the surfaces of a plurality of nanochannels included in the modified ordered mesoporous carbon, than in the inside of bulk carbon. As the modified ordered mesoporous carbon includes the plurality of nanochannels, an effective contact area with lithium ions is enlarged, and thus an excess of lithium metal can be easily formed. In addition, the lithium ions or the formed lithium metal can be easily diffused through the first anode active material layer. As a result, the first anode active material layer including the modified aligned mesoporous carbon may help uniform lithium metal deposition on the anode current collector.

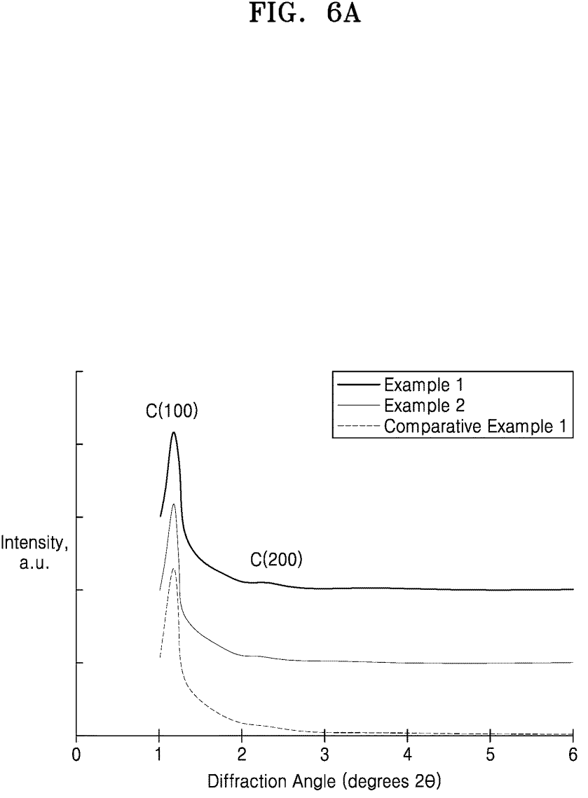

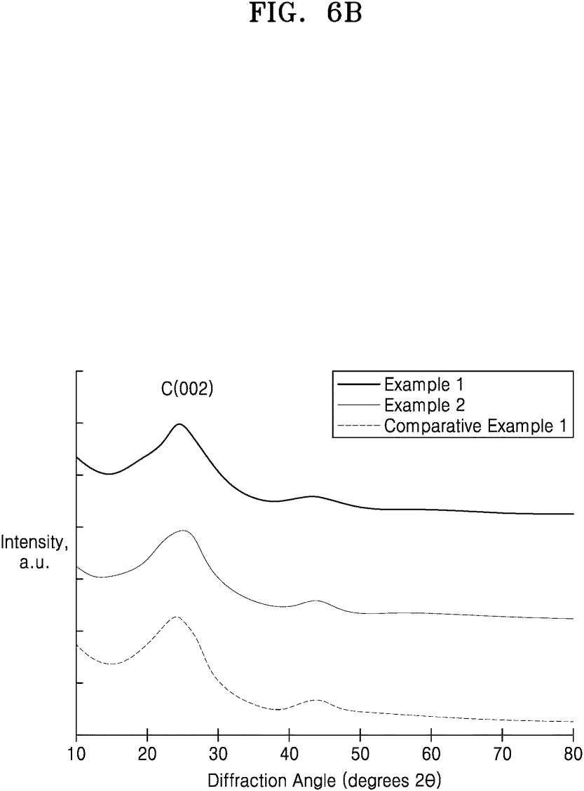

The modified ordered mesoporous carbon may have an amorphous structure. As the modified ordered mesoporous carbon has an amorphous structure, for example, lithium may be deposited on the surface of the modified ordered mesoporous carbon. In a carbonaceous material having a crystalline structure, such as graphite, lithium ions are deposited and intercalated or dissolved only between layers of the crystalline carbon, and thus, reaction sites of the lithium ions are restricted. In a carbonaceous material having an amorphous structure, there is no such limitation of reaction sites, and thus the reaction area may be substantially increased. While the dissolution rate of lithium is reduced in the amorphous carbonaceous material of the prior art, the disclosed modified ordered mesoporous carbon includes a plurality of nanochannels, and thus the rate of diffusion of lithium through the nanochannels is increased. Whether the modified ordered mesoporous carbon has an amorphous structure can be confirmed by low-angle X-ray diffraction (XRD) spectroscopy. As an example, FIG. 6A can be referred to.

The modified ordered mesoporous carbon may have a particle size of, for example, about 50 nanometers (nm) to about 2 micrometers (µm), about 0.1 µm to 11 µm, or about 50 nm or greater to less than about 1 µm. As the modified ordered mesoporous carbon has a size within these ranges, an all-solid secondary battery having further improved cycle characteristics may be provided. The modified ordered mesoporous carbon may be, for example, in the form of particles. The modified ordered mesoporous particles may be, for example, nanoparticles having a particle size of about 50 nm or greater and less than about 2 µm, or about 50 nm or greater and less than about 1 µm. The nanoparticles may be particles having a size of less than 1 µm. The size of the modified ordered mesoporous carbon may be, for example, an average particle diameter. The size of the modified ordered mesoporous carbon may be, for example, a median particle diameter (D50) measured using a laser diffraction type or dynamic light scattering type particle size distribution analyzer. The median particle diameter (D50) is measured using, for example, a laser scattering particle size distribution analyzer (for example, Horiba LA-920), and is a particle diameter value at which 50% by volume of the particles are smaller particles. Alternatively, the size of the modified ordered mesoporous carbon is an arithmetic mean value of the sizes of particles obtained from a scanning electron microscope (SEM) image. The particle size is the particle diameter if the particle is spherical, and is the maximum distance value between any two ends of a particle if the particle is non-spherical.

The size of pores included in the modified ordered mesoporous carbon may be, for example, about 2 nm to about 20 nm, about 2 nm to about 10 nm, or about 2 nm to about 5 nm. As the modified ordered mesoporous carbon has a pore size within these ranges, an all-solid secondary battery that enables more uniform deposition of lithium on the anode current collector may be provided. The pore size of the modified ordered mesoporous carbon may be measured, for example, by a nitrogen adsorption or by a transmission electron microscopy. See, for example, E. P. Barrett, L. G. Joyner, and P. P. Halenda, “The determination of pore volume and area distributions in porous substances. I. Computations from nitrogen isotherms,” J. Am. Chem. Soc. (1951), 73, 373-380.

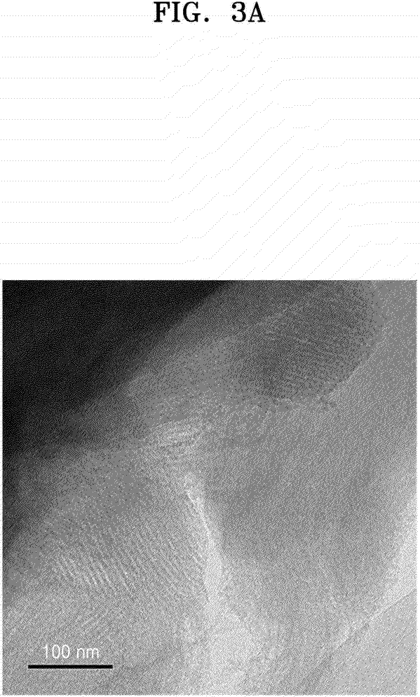

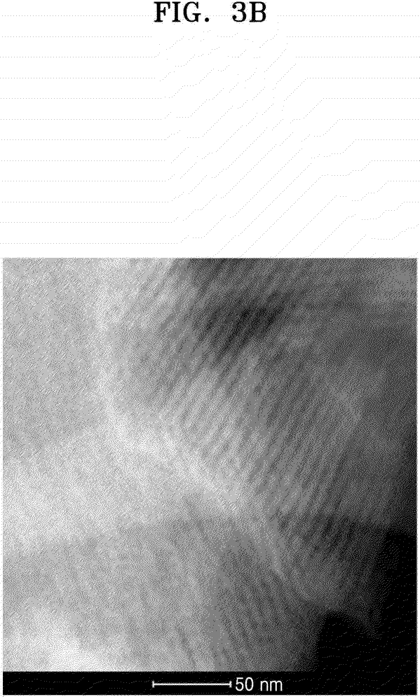

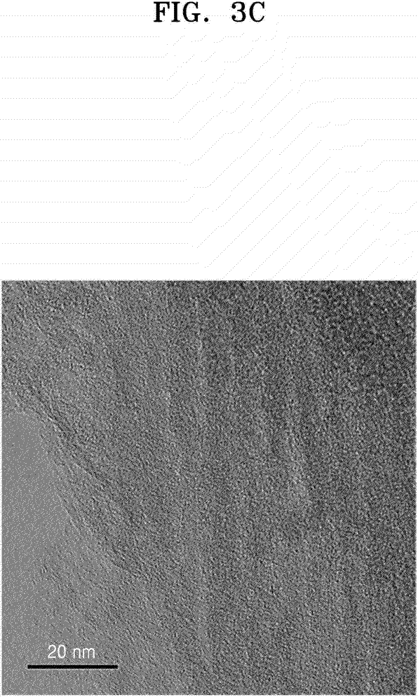

The pores included in the modified ordered mesoporous carbon may form, for example, nanochannels. For example, a plurality of pores are connected to form a nanochannel. Referring to FIGS. 3A to 3C, the modified ordered mesoporous carbon may comprise a plurality of nanochannels arranged in one direction. The sizes of pores are, for example, the diameters of the nanochannels. The plurality of nanochannels provide a diffusion path for lithium, and thus may serve as lithium conduction channels. For example, lithium can pass the first anode active material layer along the surfaces of the plurality of nanochannels.

The modified ordered mesoporous carbon can have a specific surface area of, for example, about 600 square meters per gram (m²/g) to about 1500 m²/g, about 600 m²/g to about 1200 m²/g, or about 800 m²/g to about 1200 m²/g. As the modified ordered mesoporous carbon has a specific surface area within these ranges, an all-solid secondary battery having further improved discharge capacity and/or high-rate characteristics can be provided. The specific surface area of the modified ordered mesoporous carbon may be measured, for example, by a nitrogen adsorption or by a transmission electron microscope. See for example, Brunauer, S.; Emmett, P. H.; Teller, E., “Adsorption of Gases in Multimolecular Layers,” Journal of the American Chemical Society. 60 (2): 309-319 (1938).

The modified ordered mesoporous carbon may have a pore volume of, for example, about 0.6 cubic centimeters per gram (cm³/g) to about 2.0 cm³/g, about 0.6 cm³/gto about 1.5 cm³/g, or about 0.6 cm³/gto about 1.0 cm³/g. As the modified ordered mesoporous carbon has a pore volume within these ranges, an all-solid secondary battery having further improved discharge capacity and/or high-rate characteristics can be provided. The pore volume of the modified ordered mesoporous carbon may be measured, for example, by a nitrogen adsorption test or by a transmission electron microscope.

The first anode active material layer 22 may additionally include a crystalline or amorphous carbonaceous material of the related art, having a porosity distinguishable from the porosity of the modified ordered mesoporous carbon. The carbonaceous material may be, for example, graphite carbon black (CB), acetylene black (AB), furnace black (FB), KETJEN black (KB), graphene, carbon nanotubes, carbon nano fibers, or the like, but is not limited thereto, and may be any suitable material that is classified as a carbonaceous material in the art. Alternatively, the first anode active material layer 22 may not additionally include a crystalline or amorphous carbonaceous material of the prior art described above, having a porosity distinguishable from the porosity of the modified ordered mesoporous carbon.

The oxygen included in the modified ordered mesoporous carbon may be, for example, an oxygen from an oxygen-containing functional group. The oxygen-containing functional group may be, for example, a hydroxyl group (—OH), a carboxyl group (—COOH), a carbonyl group (—C(═O)—), or the like, but is not limited thereto. For example, the oxygen-containing functional group may be introduced onto the surface of ordered mesoporous carbon during a modification process. For example, the oxygen-containing functional group may be bonded to the modified ordered mesoporous carbon via a covalent bond.

Referring to FIGS. 1 and 2, for example, the first anode active material layer 22 may additionally include a first metal oxide, a first metal, or a combination thereof.

For example, the first anode active material layer 22 may include both the modified ordered mesoporous carbon and a first metal oxide, a first metal, or a combination thereof at the same time. The first metal oxide, the first metal, or a combination thereof that is additionally included in the first anode active material layer may be disposed on the modified ordered mesoporous carbon. The first metal oxide, the first metal, or a combination thereof may be uniformly distributed in the first anode active material layer 22 by disposing in the pores and/or channels of the modified ordered mesoporous carbon.

For example, the oxygen included in the modified ordered mesoporous carbon may be oxygen included in the first metal oxide. The first metal oxide may be, for example, a compound represented by the formula MOx (wherein M is a 3^{rd}, 4^{th}, or 5^{th} period metal element belonging to Groups 3 to 14 of the periodic table of elements, and 0<x≤5). For example, the first metal oxide included in the modified ordered mesoporous carbon may be disposed on the surface of the modified ordered mesoporous carbon. For example, the first metal oxide included in the modified ordered mesoporous carbon may be continuously or discontinuously arranged along the surfaces of the plurality of nanochannels included in the modified ordered mesoporous carbon. For example, the first metal oxide included in the modified ordered mesoporous carbon may form a conformal coating layer conforming to the surface contour of the modified ordered mesoporous carbon.

For example, the first metal oxide included in the modified ordered mesoporous carbon may have an amorphous structure. As the first metal oxide has an amorphous structure, the diffusion rate of lithium on the surface of the first metal oxide may be further improved.

For example, the first metal oxide may have a particle size of about 1 nm to about 1 µm, about 1 nm to about 100 nm, about 1 nm to about 10 nm, or about 1 nm to about 2 nm. The first metal oxide may be, for example, in the form of particles. The particle size of the first metal oxide can be, for example, an average particle diameter. The size of the first metal oxide may be an arithmetic average value of the particle sizes obtained from a scanning electron microscope (SEM) image. The particle size may be the diameter of a particle if the particle is spherical, and is the maximum distance value between any two ends of a particle if the particle is non-spherical.

For example, the first metal oxide may be an oxide of a 3^{rd}, 4^{th}, or 5^{th} period metal belonging to Group 3 to Group 14 of the periodic table of the elements. The first metal oxide may include, for example, FeOx (wherein 0<x≤2), FeO, FeO₂, Fe₂O₃, Fe₃O₄, AlOx (wherein 0<x≤2), Al₂O₃, SnOx (wherein 0<x≤2), SnO, GeOx (wherein 0<x≤2), GeO, SiOx (wherein 0<x≤2), SiO, SiO₂, ScOx (wherein 0<x≤2), Sc₂O₃, CrOx (wherein 0<x≤5), CrO, Cr₂O₃, CrO₂, CrO₃, CrO₅, MnOx (wherein 0<x≤3), MnO, Mn₂O₃, Mn₃O₄, MnO₂, MnO₃, CoOx (wherein 0<x≤2), CoO, Co₂O₃, Co₃O₄, NiOx (wherein 0<x≤2), NiO, Ni₂O₃, CuOx (wherein 0<x≤2), CuO, CuO₂, Cu₂O₃, Cu₂O, or a combination thereof. As the modified ordered mesoporous carbon includes the first metal oxide, the all-solid secondary battery may have further improved discharge capacity.

For example, the first metal included in the modified ordered mesoporous carbon may be derived from the first metal oxide. The first metal may include, for example, Fe, Al, Sn, Ge, Si, Sc, Cr, Mn, Co, Ni, Cu, or a combination thereof. The first metal may be generated during a process of disposing the first metal oxide or may be derived from the first metal oxide, e.g., by reduction.

The amount of the first metal, the first metal oxide, or a combination thereof may be, for example, about 0.1 weight percent (wt%) to about 5 wt%, or about 0.1 wt% to about 2 wt%, based on a total weight of the modified ordered mesoporous carbon, when analyzed by inductively coupled plasma analysis. As the modified ordered mesoporous carbon includes a first metal, a first metal oxide, or a combination thereof within these ranges, the all-solid secondary battery may have further improved cycle characteristics. For example, when the amount of the first metal oxide disposed on the surface of the modified ordered mesoporous carbon is too low, lithophilicity may be reduced. For example, when the amount of the first metal oxide disposed on the surface of the modified ordered mesoporous carbon is too high, the surface of the modified ordered mesoporous carbon may substantially have insulation property, and the electronic conductivity of the modified ordered mesoporous carbon may be reduced.

For example, the first anode active material layer 22 may additionally include a second metal, a second metal oxide, or a combination thereof.

The first anode active material layer 22 includes the modified ordered mesoporous carbon, and the modified ordered mesoporous carbon may further include, for example, a second metal, a second metal oxide, or a combination thereof. The second metal, the second metal oxide, or a combination thereof may be disposed on the surface of the modified ordered mesoporous carbon. The second metal, the second metal oxide, or a combination thereof may be disposed on the surfaces of the plurality of nanochannels included in the modified ordered mesoporous carbon. The second metal is, for example, a metal anode active material. For example, the metal anode active material may include silver (Ag), tin (Sn), germanium (Ge), indium (In), silicon (Si), gallium (Ga), aluminum (Al), titanium (Ti), zirconium (Zr), niobium (Nb), antimony (Sb), bismuth (Bi), gold (Au), platinum (Pt), palladium (Pd), magnesium (Mg), zinc (Zn), an alloy thereof, or a combination thereof, but is not limited thereto. Any suitable metal anode active material that is known to form an alloy or a compound with lithium in the art may be used. The second metal oxide is, for example, a metal oxide anode active material. The metal oxide anode active material is, for example, TiO₂, SiOx (wherein 0<x<2), or a combination thereof. As the first anode active material layer 22 includes a second metal, a second metal oxide, or a combination thereof, the charge capacity and/or discharge capacity of the all-solid secondary battery may be further improved.

The metal, the metal oxide, or a combination thereof may be, for example, in the form of particles. The diameter of the particles may be, for example, about 4 µm or less, or about 300 nm or less. The diameter of the metal anode active material may be, for example, about 10 nm to about 4 µm, to about 10 nm to about 1 µm, about 10 nm to about 500 nm, or about 10 nm to about 300 nm. When the metal anode active material has a particle diameter within these ranges, the all-solid secondary battery 1 may have further improved characteristics. The particle diameter of the metal, and metal oxide anode active material may be, for example, a median particle diameter (D50) measured using a laser particle size distribution analyzer.

When the first anode active material layer 22 further includes, for example, a second metal, a second metal oxide, or a combination thereof, a weight ratio of the modified ordered mesoporous carbon relative to the second metal, for example, silver (Ag) or the like in the first anode active material layer 22 may be, for example, about 10:1 to about 1:2, about 5:1 to about 1:1, or about 4:1 to about 2:1, but is not necessarily limited thereto, and may be selected according to characteristics of the all-solid secondary battery 1. As the first anode active material layer 22 has such a composition, the all-solid secondary battery 1 may have further improved cycle characteristics.

The amount of the modified ordered mesoporous carbon included in the first anode active material layer 22 may be, for example, about 90 wt% to about 99 wt%, or about 90 wt% to about 95 wt%, with respect to the total weight of the first anode active material layer. As the first anode active material layer 22 includes the modified ordered mesoporous carbon within these amount ranges, the all-solid secondary battery may have further improved discharge capacity and cycle characteristics.

For example, the first anode active material layer 22 may further include a binder. The binder is, for example, styrene-butadiene rubber (SBR), carboxymethyl cellulose (CMC), polytetrafluoroethylene, polyvinylidene fluoride, polyethylene, a vinylidene fluoride/hexafluoropropylene copolymer, polyacrylonitrile, polymethylmethacrylate, or a combination thereof, but is not limited thereto, and any suitable material that can be used as a binder may be used. The binder may be composed of a single type of a binder or a combination of two or more types of binders.

An amount of the binder included in the first anode active material layer 22 may be about 1 wt% to about 10 wt%, or about 5 wt% to about 10 wt%, with respect to the total weight of the first anode active material layer. By selecting the amount and the type the modified ordered mesoporous carbon and the type and the amount of the binder or the like that are included in the first anode active material layer 22, the film strength of the first anode active material layer 22 may be controlled.

Referring to FIGS. 1 and 2, in the all-solid secondary battery 1, a ratio of the charge capacity of the first anode active material layer 22 to the charge capacity of a cathode active material layer 12, that is, a capacity ratio, satisfies the condition represented by Expression 1:

$$\text{0} \text{.01<b/a<1}$$

wherein in Expression 1, a is a charge capacity (e.g., in mAh) of the cathode active material layer 12, and
b is a charge capacity (e.g., in mAh) of the first anode active material layer 22.

The capacity ratio is, for example, 0.01<b/a≤0.9, 0.01<b/a≤0.7, 0.01<b/a≤0.5, 0.01 <b/a≤0.45, 0.01 <b/a≤0.4, 0.02≤b/a≤0.3, or 0.03≤b/a≤0.25.

The charge capacity of the cathode active material layer 12 may be obtained by multiplying a specific capacity on charge (e.g., oxidation, in mAH/g) of a cathode active material by the mass of the cathode active material in the cathode active material layer 12. When a plurality of cathode active materials are used, for each cathode active material, the value of the specific capacity multiplied by the mass may be calculated, and the sum of these values may be referred to as the specific capacity of the cathode active material layer 12. The charge capacity of the first anode active material layer 22 is also calculated using the same method. The charge capacity of the first anode active material layer 22 may be obtained by multiplying a specific capacity on charge (e.g., reduction, in mAH/g) of an anode active material by the mass of the anode active material in the anode active material layer 22. When a plurality of anode active materials are used, for each anode active material, the value of the specific capacity multiplied by the mass thereof may be calculated, and the sum of these values may be referred to as the charge capacity of the first anode active material layer 22. Here, the specific capacity of the cathode and anode active materials may be determined using an all-solid half-cell using lithium metal as a counter electrode. In practice, the charge capacities of the cathode active material layer 12 and the first anode active material layer 22 may be directly measured using an all-solid half-cell.

A specific method of directly measuring a charge capacity may be, for example, a method as described below. First, the charge capacity of the cathode active material layer 12 is measured by manufacturing an all-solid half-cell using the cathode active material layer as a working electrode and Li as a counter electrode and performing constant current-constant voltage (CC-CV) charging from OCV (open voltage) to the upper limit charge voltage. The upper limit charge voltage may be as defined by the standard of JIS C 8712: 2015, and refers to a voltage obtainable by applying 4.25 V to a lithium cobalt oxide-based cathode and the provision of JIS C 8712: 2015 (A.3.2.3. Safety requirements for cases using other upper limit charge voltages) to other cathodes. The charge capacity of the first anode active material layer 22 is measured by manufacturing an all-solid half-cell using the first anode active material layer as a working electrode and Li as a counter electrode and performing CC-CV charging from OCV (open voltage) to 0.01 V.

For example, the test cells described above may be manufactured using a method as below. The cathode active material layer 12 or the first anode active material layer 22 for measuring the charge capacity is perforated in a disc form having a diameter of 13 mm. 200 mg of the same solid electrolyte powder as used in the all-solid secondary battery 1 is solidified at 40 megapascal (MPa) to form a pellet having a diameter of 13 mm and a thickness of about 1 mm. The pellet is inserted into a tube having an inner diameter of 13 mm, the cathode active material layer 12 or the first anode active material layer 22 perforated into a disc form is inserted through one end of the tube, and a lithium foil having a diameter of 13 mm and a thickness of 0.03 mm is inserted through the other end of the tube. In addition, one stainless steel disc is inserted into each of the two sides of the tube, and the entire tube is pressed with 300 MPa in the axial direction of the tube to integrate the contents. The integrated contents are removed from the tube, sealed in a case under a constant pressure of 22 MPa, and used as a test cell. The charge capacity of the cathode active material layer 12 may be measured, for example, by performing CC-charging on the test cell manufactured as above, with a current density of 0.1 mA and then CV-charging to 0.02 mA. The charge capacity measured as described above is divided by the mass of each active material, to thereby calculate the specific capacity of each active material layer. The initial charge capacity of the cathode active material layer 12 and the first anode active material layer 22 may be an initial charge capacity that is measured at charging on the first cycle.

The capacity ratio is greater than 0.01. When the capacity ratio is 0.01 or less, the characteristics of the all-solid secondary battery may be deteriorated. For this reason, the anode active material layer 22 may not function sufficiently as a protective layer. For example, when the thickness of the anode active material layer 22 is very small, the capacity ratio may be 0.01 or less. In this case, it is likely that the anode active material layer 22 may collapse due to repeated charging and discharging, and thus lithium dendrites are deposited and grow. As a result, the characteristics of the all-solid secondary battery 1 may be deteriorated. The capacity ratio may also be 1.0 or less. When the capacity ratio is greater than 1, the deposited amount of lithium in the anode may be reduced, and the battery capacity may be reduced. For the same reason, the capacity ratio may be 0.5 or less. In addition, by having a capacity ratio of less than 0.25, the output characteristics of the all-solid secondary battery may be further improved. For this reason, the capacity ratio may be less than 0.25, e.g., about 0.1 to about 0.5, about 0.15 to about 0.5, or about 0.2 to about 0.3.

The thickness of the first anode active material layer 22 is not particularly limited as long as the capacity ratio is satisfied, and for example, may be about 1% to about 50%, about 1% to about 40%, about 1% to about 30%, about 1% to about 20%, or about 1% to about 10% of the thickness of the cathode active material layer 12. As the thickness of the first anode active material layer 22 is smaller than the thickness of the cathode active material layer 12, the all-solid secondary battery may have improved energy density.

The thickness of the first anode active material layer 22 is not particularly limited as long as the capacity ratio is satisfied, and may be, for example, about 1 µm to about 30 µm, about 1 µm to about 25 µm, or about 5 µm to about 25 µm. When the first anode active material layer 22 has a thickness within these ranges, a short-circuit in the all-solid secondary battery 1 may be suppressed, and cycle characteristics may be further improved. When the thickness of the first anode active material layer 22 is too thin, the physical properties of the all-solid secondary battery 1 may not be sufficiently improved. When the thickness of the first anode active material layer 22 is too large, the all-solid secondary battery 1 may have reduced energy density, and may have increased internal resistance due to the first anode active material layer 22, and thus it may be difficult for the all-solid secondary battery 1 to have improved cycle characteristics.

Referring to FIG. 2, for example, the all-solid secondary battery 1 may further include a second anode active material layer 23 disposed between the anode current collector 21 and the first anode active material layer 22. The second anode active material layer 23 may be a plated lithium layer, a non-plated lithium layer, a non-plated lithium-alloyable metal layer, or a combination thereof. The plated lithium layer is a lithium layer deposited during a charging process. The non-plated lithium layer is a lithium layer that is not deposited during the charging process and is provided in other ways. The non-plated lithium layer is, for example, a lithium foil or a lithium sheet. The non-plated lithium-alloyable metal layer is a layer that includes a metal element other than lithium and is not deposited during the charging process and is provided in other ways. The non-plated lithium-alloyable metal layer may be, for example, a metal layer including gold, silver, zinc, tin, indium, silicon, aluminum, bismuth, or the like.

For example, the second anode active material layer 23 may be disposed between the anode current collector 21 and the first anode active material layer 22 by charging after assembly of the all-solid secondary battery 1. Specifically, as described in connection with the capacity ratio of Expression 1, the charge capacity of the cathode active material layer 12 is set to exceed the charge capacity of the first cathode active material layer 22. For example, the all-solid secondary battery 1 is charged to exceed the charge capacity of the first anode active material layer 22. That is, the first anode active material layer 22 is overcharged. At the initial stage of charging, lithium is deposited and/or adsorbed in the first anode active material layer 22. That is, the modified ordered mesoporous carbon forms a compound with lithium ions moved from a cathode layer 10, or form lithium on the surface thereof, or deposit lithium on the surface thereof. When further charging is performed to exceed the capacity of the first anode active material layer 22, as shown in FIG. 2, lithium is deposited on the rear surface of the first anode active material layer 22, i.e., between the anode current collector 21 and the first anode active material layer 22, and thus, forms the second anode active material layer 23. That is, a plated lithium layer is formed as the second anode active material layer 23. The second anode active material layer 23 consists of mainly lithium metal, and may additionally include a trace amount of an element other than lithium. This may occur when the anode active material additionally contains a specific material, i.e., an element that forms an alloy or a compound with lithium. During discharging, lithium in the first anode active material layer 22 and the plated lithium layer (e.g., the second anode active material layer) 23 is ionized and moves toward the cathode layer 10. Therefore, in the all-solid secondary battery 1 having a capacity ratio as described above, plated lithium may be used as an anode active material. Further, the first anode active material layer 22 covers the plated lithium layer 23 (e.g., the second anode active material layer), and thus, may be used as a protective layer for the plated lithium layer 23 (e.g., the second anode active material layer) and at the same time may suppress deposition and growth of lithium dendrites. Due to this, a short-circuit and capacity reduction in the all-solid secondary battery 1 are suppressed, and furthermore, the all-solid secondary battery 1 has improved cycle characteristics.

In other embodiments, the second anode active material layer 23 may be disposed between the anode current collector 21 and the first anode active material layer 22 before assembly of the all-solid secondary battery 1. For example, the second anode active material layer 23 may be stacked on the anode current collector 21. That is, as the second anode active material layer 23, a non-plated lithium layer is disposed. The non-plated lithium layer may be, for example, a lithium foil. The second anode active material layer 23 is a lithium metal layer or a lithium alloy layer, and thus may serve as a lithium reservoir. The lithium alloy may be, for example, a Li—Al alloy, a Li—Sn alloy, a Li—In alloy, a Li—Ag alloy, a Li—Au alloy, a Li—Zn alloy, a Li—Ge alloy, or a Li—Si alloy. However, embodiments are not limited to these alloys, and any suitable lithium alloy may be used.

A thickness of the second anode active material layer 23 may be, for example, about 10 µm to about 200 µm, about 10 µm to about 100 µm, or about 20 µm to about 100 µm. The thickness of the second anode active material layer 23 may be measured by observing the average thickness of a cross-section of the all-solid secondary battery 1 with a scanning electron microscope (SEM) after charging the all-solid secondary battery 1.

The first anode active material layer 22 may further include an additive that is used in the all-solid secondary battery of the related art, for example, a filler, a dispersing agent, or an ionic conducting agent.

For example, the anode current collector 21 may consist of a material which does not react with lithium to form an alloy or compound. The material of the anode current collector 21 may be, for example, copper (Cu), stainless steel (SUS), titanium (Ti), iron (Fe), cobalt (Co), nickel (Ni), or the like. However, embodiments are not limited thereto. Any suitable material available in the art as an anode current collector may be used. The anode current collector 21 may include one of the above-listed metals or an alloy or a coated material of two or more of the above-listed metals. The anode current collector 21 may be, for example, in the form of a plate or a foil.

### Solid Electrolyte Layer

Referring to FIGS. 1 and 2, the solid electrolyte layer 30 may be arranged between the cathode layer 10 and the anode layer 20 and include a solid electrolyte.

As the solid electrolyte, an oxide solid electrolyte, a sulfide solid electrolyte, a polymer solid electrolyte, or a combination thereof may be used.

The oxide solid electrolyte may be in a crystalline state or an amorphous state, or may be a crystalline and amorphous mixed state.

The sulfide solid electrolyte may be in a crystalline state, or may be in an amorphous state, or may be a crystalline and amorphous mixed state.

The polymer solid electrolyte may be in a crystalline state, or may be in an amorphous state, or may be a crystalline and amorphous mixed state.

The oxide solid electrolyte may include, for example, Li_{i+x+y}AlₓTi₂₋ₓSi_{y}P_{3-y}O₁₂ (wherein 0<x<2 and 0≤y<3), BaTiO₃, Pb(ZrₓTi₁₋ₓ)O₃ (PZT) (0≤x≤1), Pb₁₋ₓLaₓZr_{1-y}Ti_{y}O₃ (PLZT, wherein 0≤x<1 and 0≤y<1), Pb(Mg₃Nb_{⅔})O₃-PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (wherein 0<x<2 and 0<y<3), LiₓAl_{y}Ti_{z}(PO₄)₃ (wherein 0<x<2, 0<y<1, and0<z<3), Li_{1+x+y}(AlₐGa₁₋ₐ)ₓ(Ti_{b}Ge_{1-b})₂₋ₓSi_{y}P_{3-y}O₁₂ (wherein 0≤x≤1, 0≤y≤1, 0≤a≤1, and 0≤b≤1), LiₓLa_{y}TiO₃ (wherein 0<x<2 and 0<y<3), Li₂O, LiOH, Li₂CO₃, LiAlO₂, Li₂O-Al₂O₃-SiO₂-P₂O₅-TiO₂-GeO₂, Li₃₊ₓLa₃M₂O₁₂ (wherein M = Te, Nb, Zr, or a combination thereof, and 0≤x≤10), Li₃₊ₓLa₃Zr_{2-y}M_{y}O₁₂ (M-doped LLZO, wherein M=Ga, W, Nb, Ta, Al, or a combination thereof, 0≤x≤10, and 0<y<2), Li₇La₃Zr₂₋ₓTaₓO₁₂ (LLZ-Ta, wherein 0<x<2), or a combination thereof. The oxide solid electrolyte may be, for example, a Garnet-type solid electrolyte. The oxide solid electrolyte may be prepared using, for example, sintering.

The oxide solid electrolyte may include, for example, Li₇La₃Zr₂O₁₂(LLZO), Li_{6.5}La₃Zr_{1.5}Ta_{0.5}O₁₂, Li_{1.3}Al_{0.3}Ti_{1.7}(PO₄)₃, Li_{0.34}La_{0.51}TiO_{2.94}, Li_{1.07}Al_{0.69}Ti_{1.46}(PO₄)₃, 50Li₄Si0₄-50Li₂BO₃, 90Li₃BO₃-10Li₂SO₄, Li_{2.9}PO_{3.3}N_{0.46}, or a combination thereof.

The sulfide solid electrolyte may be, for example, Li₂S-P₂S₅, Li₂S-P₂S₅-LiX (wherein X is a halogen), Li₂S-P₂S₅-Li₂O, Li₂S-P₂S₅-Li₂O-Lil, Li₂S-SiS₂, Li₂S-SiS₂-Lil, Li₂S-SiS₂-LiBr, Li₂S-SiS₂-LiCl, Li₂S-SiS₂-B₂S₃-Lil, Li₂S-SiS₂-P₂S₅-Lil, Li₂S-B₂S₃, Li₂S-P₂S₅-ZₘSₙ (wherein m and n are each independently a positive number, and Z is Ge, Zn, Ga, or a combination thereof), Li₂S-GeS₂, Li₂S-SiS₂-Li₃PO₄, Li₂S-SiS₂-LiₚMO_{q} (wherein p and q are each independently a positive number, and M is P, Si, Ge, B, Al, Ga, or In) Li₇₋ₓPS₆₋ ₓClₓ (wherein 0≤x≤2), Li₇₋ₓPS₆₋ₓBrₓ (wherein 0≤x≤2), Li₇₋ₓPS₆₋ₓlₓ (wherein 0≤x≤2), or a combination thereof. The sulfide-based solid electrolyte may be prepared using a start source material, for example, Li₂S, P₂S₅, or the like, by melt quenching or mechanical milling. After these treatments, thermal treatment may be performed. The sulfide solid electrolyte may be amorphous, crystalline, or a mixed state thereof.

In addition, the sulfide solid electrolyte may be, for example, any of the above-listed sulfide solid electrolyte materials including at least sulfur (S), phosphorous (P), and lithium (Li) as constituent elements. For example, the sulfide solid electrolyte may be a material including Li₂S-P₂S₅. When a sulfide solid electrolyte including Li₂S-P₂S₅ is used, a mixed molar ratio of Li₂S to P₂S₅ (Li₂S:P₂S₅) may be, for example, in a range of about 50:50 to about 90:10. The sulfide solid electrolyte may include, for example, Li₇P₃S₁₁, Li₇PS₆, Li₄P₂S₆, Li₃PS₆, Li₃PS₄, Li₂P₂S₆, or a combination thereof.

The sulfide solid electrolyte may include, for example, an argyrodite-type solid electrolyte represented by Formula 1.

$${\text{Li}}^{+} {}_{\text{12-n-x}} {\text{A}}^{\text{n+}} {\text{X}}^{\text{2-}} {}_{\text{6-x}} {\text{Z}}^{\text{-}} {}_{\text{x}} \text{.}$$

In Formula 1, A may be P, As, Ge, Ga, Sb, Si, Sn, Al, In, Ti, V, Nb, or Ta, X may be S, Se, Te, or a combination thereof, Z may be Cl, Br, I, F, CN, OCN, SCN, N₃, or a combination thereof, 1≤n≤5, and 0≤x≤2.

The sulfide solid electrolyte may be an argyrodite-type compound including Li₇₋ ₓPS₆₋ₓClₓ (wherein 0≤x≤2), Li₇₋ₓPS₆₋ₓBrₓ (wherein 0≤x≤2), Li₇₋ₓPS₆₋ₓlₓ (wherein 0≤x≤2), or a combination thereof. In particular, the sulfide solid electrolyte may be an argyrodite-type compound including Li₆PS₆Cl, Li₆PS₅Br, Li₆PS₅I, or a combination thereof.

The polymer solid electrolyte may be, for example, a solid electrolyte including an ion-conductive polymer and a lithium salt, a solid electrolyte including a polymeric ionic liquid (PIL) and a lithium salt, or a combination thereof.

The ion-conductive polymer may be a polymer including an ion-conductive repeating unit on the backbone or a side chain thereof. The ion-conductive repeating unit is a unit having ionic conductivity and may be, for example, an alkylene oxide unit, a hydrophilic unit, or the like. The ion-conductive polymer may include, as an ion-conductive repeating unit, for example, an ether-based monomer, an acrylic monomer, a methacrylic monomer, a siloxane-based monomer, or a combination thereof. The ion-conductive polymer may be, for example, polyethylene oxide, polypropylene oxide, polymethyl methacrylate, polyethyl methacrylate, polydimethylsiloxane, polyacrylic acid, polymethacrylic acid, polymethyl acrylate, polyethyl acrylate, poly2-ethylhexyl acrylate, polybutyl methacrylate, poly2-ethylhexyl methacrylate, polydecyl acrylate, polyethylene vinyl acetate, or a combination thereof. The ion-conductive polymer may, for example, polyethylene oxide (PEO), polyvinyl alcohol (PVA), polyvinylpyrrolidone (PVP), polysulfone, or a combination thereof.

For example, the polymeric ionic liquid (PIL) may include a repeating unit including: i) least one cation selected from ammonium-based cations, pyrrolidinium-based cations, pyridinium-based cations, pyrimidinium-based cations, imidazolium-based cations, piperidinium-based cations, pyrazolium-based cations, oxazolium-based cations, pyridazinium-based cations, phosphonium-based cations, sulfonium-based cations, triazole-based cations, or a combination thereof; and at least one anion selected from among BF₄₋, PF₆₋, AsF₆₋, SbF₆₋, AlCl₄₋, HSO₄₋, ClO₄₋, CH₃SO₃₋, CF₃CO₂₋, (CF₃SO₂)₂N-, Cl-, Br-, I-, BF₄₋, SO₄₋, PF₆₋, ClO₄₋, CF₃SO₃₋, CF₃CO₂₋, (C₂F₅SO₂)₂N-, (C₂F₅SO₂)(CF₃SO₂)N-, NO₃₋, Al₂Cl₇₋, AsF₆₋, SbF₆₋, CF₃COO⁻, CH₃COO⁻, CF₃SO₃₋, (CF₃SO₂)₃C⁻, (CF₃CF₂SO₂)₂N⁻, (CF₃)₂PF₄₋, (CF₃)₃PF₃₋, (CF₃)₄PF₂₋, (CF₃)₅PF⁻, (CF₃)₆P⁻, SF₅CF₂SO₃₋, SF₆CHFCF₂SO₃₋, CF₃CF₂(CF₃)₂CO⁻, (CF₃SO₂)₂CH⁻, (SF₅)₃C⁻, (O(CF₃)₂C₂(CF₃)₂O)₂PO⁻, (CF₃SO₂)₂N-, or a combination thereof. The polymeric ionic liquid (PIL) may be, for example, poly(diallyldimethylammonium) (TFSI), poly(1-allyl-3-methylimidazolium trifluoromethanesulfonylimide), poly(N-Methyl-N-propylpiperidinium bis(trifluoromethanesulfonyl)imide), or a combination thereof.

The lithium salt in the polymer solid electrolyte may be, for example, LiPF₆, LiBF₄, LiSbF₆, LiAsF₆, LiClO₄, LiCF₃SO₃, Li(CF₃SO₂)₂N, Li(C₄F₉SO₃, LiAlO₂, LiAlCl₄, LiN(CₓF₂ₓ₊₁SO₂)(C_{y}F_{2y+1}SO₂) (wherein 1≤x≤20 and 1≤y≤20), LiCl, Lil, or a combination thereof.

For example, the solid electrolyte layer 30 may further include a binder. The binder included in the solid electrolyte layer 30 may be, for example, a styrene-butadiene rubber (SBR), polytetrafluoroethylene (PTFE), polyvinylidene fluoride (PVDF), or polyethylene. However, embodiments are not limited thereto. Any suitable binder available in the art may be used. The binder of the solid electrolyte layer 30 may be the same as or different from the binders of the cathode active material layer 12 and the first anode active material layer 22.

The solid electrolyte layer 30 may use a solid electrolyte including only an oxide solid electrolyte as described herein. For example, the solid electrolyte layer 30 may consist of an oxide solid electrolyte.

The solid electrolyte layer 30 may include, for example, a liquid-impermeable ion-conductive composite membrane. The liquid-impermeable ion-conductive composite membrane may include an oxide solid electrolyte as described herein, a composite of an oxide solid electrolyte as described herein and an ion-conductive polymer, or a combination thereof. The ion-conductive polymer may be, for example, polyethylene oxide (PEO), but is not necessarily limited thereto.

### Cathode Layer

The cathode layer 10 may include a cathode current collector 11 and a cathode active material layer 12.

The cathode current collector 11 may be a plate or a foil that includes indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The cathode current collector 11 may be omitted.

The cathode active material layer 12 may include, for example, a cathode active material.

The cathode active material may be a cathode active material capable of absorption and desorption of lithium ions. The cathode active material may be, for example, a lithium transition metal oxide, such as lithium cobalt oxide (LCO), lithium nickel oxide, lithium nickel cobalt oxide, lithium nickel cobalt aluminum oxide (NCA), lithium nickel cobalt manganese oxide (NCM), lithium manganate, or lithium iron phosphate; nickel sulfide; copper sulfide; lithium sulfide; iron oxide; or vanadium oxide. However, embodiments are not limited thereto. Any suitable cathode active material available in the art may be used. These cathode active materials may be used alone or in a combination of at least two thereof.

The lithium transition metal oxide may be, for example, a compound represented by one of the following formulae: LiₐA_{1-b}B′_{b}D₂ (wherein 0.90 ≤ a ≤ 1 and 0 ≤ b ≤ 0.5); LiₐE₁₋ _{b}B′_{b}O_{2-c}D_{c} (wherein 0.90 ≤ a ≤ 1, 0 ≤ b ≤ 0.5, and 0 ≤ c ≤ 0.05); LiE_{2-b}B′_{b}O_{4-c}D_{c} (wherein 0 ≤ b ≤ 0.5, and 0 ≤ c ≤ 0.05); LiₐNi_{1-b-c}Co_{b}B′_{c}Dα (wherein 0.90 ≤ a ≤ 1, 0 ≤ b ≤ 0.5, 0 ≤ c ≤ 0.05, and 0 < a ≤ 2); LiₐNi_{1-b-c}Co_{b}B′_{c}O_{2-α}F′_{α} (wherein 0.90 ≤ a ≤ 1, 0 ≤ b ≤ 0.5, 0 ≤ c ≤ 0.05, and 0 < α < 2); LiₐNi_{1-b-c}Co_{b}B′_{c}O_{2-α}F′₂ (wherein 0.90 ≤ a ≤ 1, 0 ≤ b ≤ 0.5, 0 ≤ c ≤ 0.05, and 0 < α < 2); LiₐNi_{1-b-c}Mn_{b}B′_{c}Dₐ (wherein 0.90 ≤ a ≤ 1, 0 ≤ b ≤ 0.5, 0 ≤ c ≤ 0.05, and 0 < α ≤ 2); LiaNi_{1-b-c}Mn_{b}B′_{c}O_{2-α}F′_{α} (wherein 0.90 ≤ a ≤ 1, 0 ≤ b ≤ 0.5, 0 ≤ c ≤ 0.05, and 0 < α < 2); LiₐNi_{1-b-c}Mn_{b}B′_{c}O_{2-α}F′₂ (wherein 0.90 ≤ a ≤ 1, 0 ≤ b ≤ 0.5, 0 ≤ c ≤ 0.05, and 0 < α < 2); LiₐNi_{b}E_{c}G_{d}O₂ (wherein 0.90 ≤ a ≤ 1, 0 ≤ b ≤ 0.9, 0 ≤ c ≤ 0.5, and 0.001 ≤ d ≤ 0.1); LiₐNi_{b}Co_{c}Mn_{d}GeO₂ (wherein 0.90 ≤ a ≤ 1, 0 ≤ b ≤ 0.9, 0 ≤ c ≤ 0.5, 0 ≤ d ≤0.5, and 0.001 ≤ e ≤ 0.1); LiₐNiG_{b}O₂ (wherein 0.90 ≤ a ≤ 1, and 0.001 ≤ b ≤ 0.1); LiₐCoG_{b}O₂ (wherein 0.90 ≤ a ≤ 1 and 0.001 ≤ b ≤ 0.1); LiₐMnG_{b}O₂ (wherein 0.90 ≤ a ≤ 1 and 0.001 ≤ b ≤ 0.1); LiₐMn₂G_{b}O₄ (wherein 0.90 ≤ a ≤ 1 and 0.001 ≤ b ≤ 0.1); QO₂; QS₂; LiQS₂; V₂O₅; LiV₂O₅; Lil′O₂; LiNiVO₄; Li_{(3-f)}J₂(PO₄)₃ (wherein 0 ≤ f ≤ 2); Li_{(3-f)}Fe₂(PO₄)₃ (wherein 0 ≤ f ≤ 2); and LiFePO₄. In the formulae above, A may be nickel (Ni), cobalt (Co), manganese (Mn), or a combination thereof; B′ may be aluminum (Al), nickel (Ni), cobalt (Co), manganese (Mn), chromium (Cr), iron (Fe), magnesium (Mg), strontium (Sr), vanadium (V), a rare earth element, or a combination thereof; D may be oxygen (O), fluorine (F), sulfur (S), phosphorus (P), or a combination thereof; E may be cobalt (Co), manganese (Mn), or combination thereof; F′ may be fluorine (F), sulfur (S), phosphorus (P), or a combination thereof; G may be aluminum (Al), chromium (Cr), manganese (Mn), iron (Fe), magnesium (Mg), lanthanum (La), cerium (Ce), strontium (Sr), vanadium (V), or a combination thereof; Q may be titanium (Ti), molybdenum (Mo), manganese (Mn), or a combination thereof; I′ may be chromium (Cr), vanadium (V), iron (Fe), scandium (Sc), yttrium (Y), or a combination thereof; and J may be vanadium (V), chromium (Cr), manganese (Mn), cobalt (Co), nickel (Ni), copper (Cu), or a combination thereof. The compounds listed above as cathode active materials may have a surface coating layer (hereinafter, also referred to as “coating layer”). Alternatively, a mixture of a compound without a coating layer and a compound having a coating layer, the compounds being selected from the compounds listed above, may be used. In some embodiments, the coating layer on the surface of such compounds may include at least an oxide, hydroxide, oxyhydroxide, oxycarbonate, or hydroxycarbonate of the coating element. In some embodiments, the compounds for the coating layer may be amorphous or crystalline. In some embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. In some embodiments, the coating layer may be formed using any method that does not adversely affect the physical properties of the cathode active material. For example, the coating layer may be formed using a spray coating method, a dipping method, or the like. The coating methods may be well understood by one of ordinary skill in the art, and thus a detailed description thereof will be omitted.

The cathode active material may include, for example a lithium salt of a transition metal oxide having a layered rock salt-type structure among the above-listed lithium transition metal oxides. The term “layered rock salt-type structure” used herein refers to a structure in which oxygen atomic layers and metal atomic layers are alternately regularly disposed in the direction of [111] planes, with each atomic layer forming a 2-dimensional (2D) plane. A “cubic rock salt-type structure” refers to a sodium chloride (NaCl)-type crystal structure, and in particular, a structure in which face-centered cubic (FCC) lattice formed by respective cations and anions are disposed in a way those ridges of the unit lattices are shifted by ½. The lithium transition metal oxide having such a layered rock salt-type structure may be, for example, a ternary lithium transition metal oxide such as LiNiₓCo_{y}Al_{z}O₂ (NCA) or LiNiₓCo_{y}Mn_{z}O₂ (NCM) (wherein 0 < x < 1, 0 < y < 1, 0 < z < 1, and x + y + z = 1) or a combination thereof. The lithium transition metal oxide having such a layered rock salt-type structure may be, for example, a ternary lithium transition metal oxide such as LiNiₓCo_{y}Mn_{z}Al_{w}O₂ (NCMA) (wherein 0 < x < 1, 0 < y < 1, 0 < z < 1, 0 < w < 1, and x + y + z + w = 1). In addition, a lithium salt of the transition metal oxide having such a layered rock-salt type structure may have a high nickel content. For example, the lithium salt of the transition metal oxide having such a layered rock-salt type structure may be a nickel-rich lithium salt of a ternary or quaternary transition metal oxide such as LiNiₐCo_{b}Al_{c}O₂ (wherein 0.5<a<1, 0<b<0.3, 0<c<0.3, and a+b+c=1), LiNiₐCo_{b}Mn_{c}O₂ (wherein 0.5<a<1, 0<b<0.3, 0<c<0.3, and a+b+c=1), or LiNiₐCo_{b}Mn_{c}Al_{d}O₂ (0.5<a<1, 0<b<0.3, 0<c<0.3, 0<c<0.3, and a+b+c+d=1) or a combination thereof. When the cathode active material includes such a ternary lithium transition metal oxide having a layered rock salt-type structure, the all-solid secondary battery 1 may have further improved energy density and thermal stability.

The cathode active material may be covered with a coating layer as described herein for the anode active material. The coating layer may be any known coating layer for cathode active materials of all-solid secondary batteries. The coating layer may include, for example, Li₂O-ZrO₂.

When the cathode active material includes, for example, a ternary lithium transition metal oxide including Ni, such as NCA or NCM, the all-solid secondary battery 1 may have an increased capacity density and elution of metal ion from the cathode active material may be reduced in a charged state. As a result, the all-solid secondary battery 1 may have improved cycle characteristics in a charged state.

The cathode active material may be in the form of particles having, for example, a true-spherical particle shape or an oval-spherical particle shape. The particle diameter of the cathode active material is not particularly limited, and may be in a range applicable to a cathode active material of an all-solid secondary battery according to the related art. An amount of the cathode active material in the cathode layer 10 is not particularly limited, and may be in a range applicable to a cathode active material of an all-solid secondary battery according to the related art.

The cathode layer 10 may further include, in addition to a cathode active material as described above, an additive(s), for example, a conducting agent, a binder, a filler, a dispersing agent, an auxiliary ionic conducting agent, or a combination thereof. The conducting agent may be, for example, graphite, carbon black, acetylene black, KETJEN black, carbon fibers, metal powder, or a combination thereof. The binder may be, for example, a styrene-butadiene rubber (SBR), polytetrafluoroethylene, polyvinylidene fluoride, polyethylene, or a combination thereof. The dispersing agent, the auxiliary ionic conducting agent, a coating agent, or the like which may be added to the cathode layer 10 may be any suitable known materials used in cathode of an all-solid secondary battery.

The cathode layer 10 may further include a solid electrolyte, a liquid electrolyte, or a combination thereof. The cathode layer 10 may include an oxide-based solid electrolyte, a sulfide-based solid electrolyte, a polymer-based solid electrolyte, or a combination thereof.

The solid electrolyte included in the cathode layer 10 may be, for example, an oxide-based solid electrolyte, a sulfide-based solid electrolyte, or a polymer-based solid electrolyte as described above in connection with the solid electrolyte layer 30.

The cathode active material layer 12 may further include, for example, a liquid electrolyte. For example, at least a portion of the cathode active material layer 10 may be impregnated with the liquid electrolyte. For example, a trace amount of the liquid electrolyte may be dropped onto the surface of the cathode active material layer 12 to wet the surface of the cathode active material layer 12.

The liquid electrolyte may include an ionic liquid, a lithium salt, or a combination thereof.

The liquid electrolyte may be a mixture of a lithium salt and an ionic liquid, a mixture of a lithium salt and a polymeric ionic liquid, or a mixture of a lithium salt and an ionic liquid and a polymeric ionic liquid. The liquid electrolyte may be non-volatile.

The ionic liquid may refer to a salt in a liquid state at room temperature or a fused salt at room temperature, each having a melting point equal to or below the room temperature and consisting of only ions. The ionic liquid may include: a) at least one cation selected from an ammonium cation, a pyrrolidinium cation, a pyridinium cation, a pyrimidinium cation, an imidazolium cation, a piperidinum cation, a pyrazolium cation, an oxazolium cation, a pyridazinium cation, a phosphonium cation, a sulfonium cation, a triazolium cation, or a combination thereof; and b) at least one anion selected from BF₄₋, PF₆₋, AsF₆₋, SbF₆₋, AlCl₄₋, HSO₄₋, ClO₄₋, CH₃SO₃₋, CF₃CO₂₋, Cl⁻, Br⁻, I⁻, BF₄₋, SO₄₋ , CF₃SO₃₋, (FSO₂)₂N-, (C₂F₅SO₂)₂N-, (C₂F₅SO₂)(CF₃SO₂)N-, (CF₃SO₂)₂N, or a combination thereof. The ionic liquid may be, for example, N-methyl-N-propylpyrrolidium bis(trifluoromethylsulfonyl)imide, N-butyl-N-methylpyrrolidium bis(3-trifluoromethylsulfonyl)im ide, 1-butyl-3-methylim idazolium bis(trifluoromethylsulfonyl)im ide, 1-butyl-3-methylim idazolium bis(trifluoromethylsulfonyl)imide), or a combination thereof.

The polymeric ionic liquid may include repeating units including: a) at least one cation selected from an ammonium cation, a pyrrolidinium cation, a pyridinium cation, a pyrimidinium cation, an imidazolium cation, a piperidinum cation, a pyrazolium cation, an oxazolium cation, a pyridazinium cation, a phosphonium cation, a sulfonium cation, a triazolium cation, or a combination thereof; and b) at least one anion selected from BF₄₋, PF₆₋, AsF₆₋, SbF₆₋, AlCl₄₋, HSO₄₋, ClO₄₋, CH₃SO₃₋, CF₃CO₂₋, (CF₃SO₂)₂N⁻, (FSO₂)₂N⁻, Cl⁻, Br⁻, I⁻, SO₄₋, CF₃SO₃₋, (C₂F₅SO₂)₂N⁻, (C₂F₅SO₂)(CF₃SO₂)N⁻, NO₃₋, Al₂Cl₇₋, (CF₃SO₂)₃C⁻, (CF₃)₂PF₄₋, (CF₃)₃PF₃₋, (CF₃)₄PF₂₋, (CF₃)₅PF⁻, (CF₃)₆P⁻, SF₅CF₂SO₃₋, SF_{S}CHFCF₂SO₃₋, CF₃CF₂(CF₃)₂CO⁻, (CF₃SO₂)₂CH⁻, (SF₅)₃C⁻, (O(CF₃)₂C₂(CF₃)₂O)₂PO⁻, or a combination thereof.

The lithium salt may be any lithium salt used in the art. The lithium salt may be, for example, LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO2)(C_{y}F_{2y+1}SO₂) (wherein 1≤x≤20 and 1≤y≤20), LiCl, Lil, or a combination thereof. A concentration of the lithium salt in the liquid electrolyte may be about 0.1 M to 5 M.

The liquid electrolyte may be present only in the cathode layer 10, and may be absent from the solid electrolyte layer 30 and the anode layer 20. For example, in a laminate of the cathode layer 10 and the solid electrolyte layer 30, when a liquid electrolyte is arranged between the cathode layer 10 and the solid electrolyte layer 30, the solid electrolyte layer 30 is impermeable to the liquid electrolyte, and thus, the liquid electrolyte is present only in the cathode layer 10, but not in the solid electrolyte layer 30.

According to another embodiment, a method of manufacturing the all-solid secondary battery 1 includes: providing an ordered mesoporous carbon optionally comprising a precursor of a first metal oxide, a precursor of a first metalloid oxide, or a combination thereof; thermally treating the ordered mesoporous carbon in an oxidizing atmosphere to prepare a modified ordered mesoporous carbon; disposing the modified ordered mesoporous carbon in the form of a layer to prepare the anode layer 20; and stacking the solid electrolyte layer 30 between the anode layer 20 and the cathode layer 10, wherein an oxygen content on the surface of the modified ordered mesoporous carbon is about 3 at% to about 10 at%, based on a total content of the surface, when determined by XPS of the surface of the modified ordered mesoporous carbon.

### Preparation of Modified Ordered Mesoporous Carbon

After an ordered mesoporous carbon is put into a reactor, heat treatment can be performed under an oxidizing atmosphere at a temperature of about 250° C. to about 400° C. for 1 to 10 hours to prepare the modified ordered mesoporous carbon. An oxygen content of the modified ordered mesoporous carbon is about 3 at% to about 10 at%, based on a total content of the surface, when determined by XPS of a surface of the modified ordered mesoporous carbon. The heat treatment temperature may be, for example, about 250° C. to about 400° C. or about 300° C. to about 350° C. The ordered mesoporous carbon may be, for example, CMK-3, CMK-5, CMK-8, FDU-15, FDU-16, or the like, but is not limited thereto, and any suitable ordered mesoporous carbon available in the art may be used.

The oxidizing atmosphere may be provided by flowing oxygen or in an air atmosphere. When the heat treatment temperature is too low, the oxygen content on the produced modified ordered mesoporous carbon surface may be reduced. When the heat treatment temperature is too high, the physical properties of the produced modified ordered mesoporous carbon may change. When the heat treatment time is too short, the oxygen content on the produced modified ordered mesoporous carbon surface may be reduced. When the heat treatment time is too long, the physical properties of the produced modified ordered mesoporous carbon may deteriorate.

In other embodiments, after an ordered mesoporous carbon including a precursor of a first metal oxide is put into a reactor, heat treatment may be performed under an oxygen atmosphere at a temperature of about 250° C. to about 400° C. for about 1 hour to about 10 hours to prepare the modified ordered mesoporous carbon including the first metal oxide. A metal oxide content of the modified ordered mesoporous carbon including the first metal oxide may be, for example, about 0.1 wt% to about 5 wt% or about 0.1 wt% to about 3 wt%, based on a total weight of the modified ordered mesoporous carbon, when determined by ICP-AES (Inductively Coupled Plasma Atomic Emission Spectroscopy). The heat treatment temperature may be, for example, about 300° C. to about 350° C.

The precursor of the first metal oxide may be a salt of a first metal. The precursor of the first metal oxide is any material that thermally decomposes under the heat treatment condition described above to form the first metal oxide. The salt of a first metal may be, for example, an organic salt of the first metal or an inorganic salt of the first metal or a combination thereof. The precursor of the first metal oxide may be, for example, an acetate of the first metal, a carbonate or the first metal, a nitrate of the first metal, or a sulfate of the first metal, or a combination thereof.

### Preparation of Laminate Of Solid Electrolyte Layer/Anode layer

The modified ordered mesoporous carbon, a binder, and the like are added to a solvent to prepare a first anode active material slurry. The solvent may be, for example, water or alcohol or a combination thereof. The prepared slurry may be coated on the solid electrolyte layer 30 and dried to prepare a first laminate in which the first anode active material composition is disposed on one surface of the solid electrolyte layer 30. Subsequently, the anode current collector 21 may be disposed on the dried first laminate and then pressed to thereby form a laminate of the solid electrolyte layer 30 and the anode layer 20. In other embodiments, by arranging, on the first laminate, a Li/Cu laminate in which a lithium metal layer is stacked on one surface of the Cu anode current collector 21, the second anode active material layer 23 which is a lithium metal layer may be arranged between the cathode current collector 21 and the solid electrolyte layer 30.

The pressing may be carried out using, for example, roll pressing or flat pressing. However, embodiments are not limited to these methods, and any pressing method used in the art may be used. A pressure applied in the pressing may be, for example, about 50 MPa to 500 MPa. The pressure application time may be, for example, about 0.1 min to about 30 min. The pressing may be carried out, for example, at a temperature from room temperature to about 90° C., or at a temperature from about 20° C. to about 90° C. In another embodiment, the pressing may be carried out at a high temperature of 100° C. or greater. The pressing may be omitted.

### Preparation Of Cathode Layer

A cathode active material, a binder, and the like as constituent materials of the cathode active material layer 12 may be added to a solvent to prepare a slurry. The prepared slurry may be coated on the cathode current collector 11 and then dried to form a laminate. The obtained laminate may be pressed to thereby form the cathode layer 10. For example, the pressing may be performed using, for example, roll pressing, flat pressing, or isotactic pressing. However, embodiments are not limited thereto, and any pressing method available in the art may be used. The pressing may be omitted. In other embodiments, the cathode layer 10 may be formed by compaction-molding a mixture of the ingredients of the cathode active material layer 12 into pellets or extending the mixture into a sheet form. When these methods are used to form the cathode layer 10, the cathode current collector 11 may be omitted.

Before the cathode layer 10 is disposed on the solid electrolyte layer 30, the surface of the cathode active material layer included in the cathode layer 10 may be impregnated with a liquid electrolyte before use.

### Preparation Of Solid Electrolyte Layer

For example, the solid electrolyte layer 30 including an oxide solid electrolyte may be prepared by thermally treating precursors of an oxide solid electrolyte material.

The oxide solid electrolyte may be prepared by contacting the precursors in stoichiometric amounts to form a mixture and thermally treating the mixture. For example, the contacting may include milling such as ball milling, or grinding. The mixture of the precursors mixed in a stoichiometric composition may be subjected to first thermal treatment under oxidizing atmosphere to prepare a first thermal treatment product. The first thermal treatment may be carried out in a temperature range less than 1000° C., for example about 200 to about 900° C. for about 1 to about 36 hours. The first thermal treatment product may be grinded. The first thermal treatment product may be grinded in a wet or dry manner. For example, the wet milling may be carried out by mixing the first thermal treatment product with a solvent such as methanol and milling the mixture using, for example, a ball mill for about 0.5 to 10 hours. Dry grinding may be performed using, for example, a ball mill without a solvent. The grinded first thermal treatment product may have a particle diameter of about 0.1 µm to 10 µm, or about 0.1 µm to 5 µm. The grinded first thermal treatment product may be dried. The grinded first thermal treatment product may be shaped in pellet form by being mixed with a binder solution, or may be shaped in pellet form by simply being pressed at a pressure of about 1 ton to about 10 tons.

The shaped product may be subjected to second thermal treatment at a temperature less than 1000° C., for example about 200 to about 900° C. for about 1 hour to about 36 hours. Through the second thermal treatment, the solid electrolyte layer 30, which is a sintered product, may be obtained. The second thermal treatment may be carried out, for example, at a temperature of about 550 to about 1000° C. For example, the first thermal treatment time may be about 1 to about 36 hours. The second thermal treatment temperature for obtaining the sintered product may be higher than the first thermal treatment temperature. For example, the second thermal treatment temperature may be higher than the first thermal treatment temperature by about 10° C. or greater, about 20° C. or greater, about 30° C. or greater, or about 50° C. or greater or about 10 to about 100° C. The second thermal treatment of the shaped product may be carried out under at least one of oxidizing atmosphere and reducing atmosphere. The second thermal treatment may be carried out under a) oxidizing atmosphere, b) reducing atmosphere, or c) oxidizing and reducing atmosphere.

### Manufacture Of all-Solid Secondary Battery

The cathode layer 10, and the laminate of the anode layer 20 and the solid electrolyte layer 30, which are formed according to the above-described methods, may be stacked such that the solid electrolyte layer 30 is interposed between the cathode layer 10 and the anode layer 20, and then be pressed to thereby manufacture the all-solid secondary battery 1.

For example, the laminate of the anode layer 20 and the solid electrolyte layer 30 may be disposed on the cathode layer 10 such that the solid electrolyte layer 30 contacts the cathode layer 10, to thereby prepare a second laminate. The second laminate may then be pressed to thereby manufacture the all-solid secondary battery 1. For example, the pressing may be performed using, for example, roll pressing, flat pressing, or isotactic pressing. However, embodiments are not limited thereto, and any pressing method available in the art may be used. A pressure applied in the pressing may be, for about 50 MPa to 750 MPa. The pressure application time may be about 0.1 min to about 30 min. The pressing may be carried out, for example, at a temperature from room temperature to 90° C. or less, or at a temperature from 20 to 90° C. In another embodiment, the pressing may be carried out at a high temperature of 100° C. or greater such as about 100° C. to about 200° C. Although the structures of the all-solid secondary battery 1 and the methods of manufacturing the all-solid secondary battery 1 are described above as embodiments, the disclosure is not limited thereto, and the constituent members of the all-solid secondary battery and the manufacturing processes may be appropriately varied. The pressing may be omitted.

One or more embodiments of the present disclosure will now be described in detail with reference to the following examples. However, these examples are only for illustrative purposes and are not intended to limit the scope of the one or more embodiments of the present disclosure.

### EXAMPLES

### Example 1: Modified Ordered Mesoporous Carbon, Heat-treated at 330° C. for 1 Hour Preparation of Modified Ordered Mesoporous Carbon

An ordered mesoporous carbon (bare OMC, particle size: 300 nm to 500 nm, UNIAM Ltd., Korea) was put into a reactor and thermally treated at 330° C. for 1 hour while oxygen was supplied at a rate of 50 mL/min, to prepare a modified ordered mesoporous carbon (modified OMC).

### Preparation of Laminate of Solid Electrolyte Layer/Anode Layer

The modified ordered mesoporous carbon and a water-soluble binder (polyvinyl alcohol grafted poly (acrylic acid) (PVA-g-PAA) were added to water and mixed to prepare a mixture. The mixture was stirred constantly using a mixer (Thinky Corporation, AR-100) while water was dropwise added thereto, to prepare a slurry.

LLZO pellets were prepared for a solid electrolyte layer. LLZO pellets (Li_{6.5}La₃Zr_{1.5}Ta_{0.5}, Toshima, Japan) were mechanically polished with a #500 SiC sandpaper for 1 hour, and then pre-treated with 1.0 M hydrochloric acid (HCl) for 10 minutes. By this pre-treatment, the LLZO pellets had rough surfaces and increased surface areas.

The slurry was coated on one surface of the pre-treated LLZO pellets to a thickness of 500 µm by using a tape casting method, and dried at 20° C. for 10 minutes and then dried at 80° C. for 10 minutes, to prepare a laminate of the first anode active material layer/solid electrolyte layer.

The first anode active material layer had a thickness of 19 µm. The composition of the first anode active material layer consisted of 93 wt% of the modified ordered mesoporous carbon (modified OMC) and 7 wt% of the binder.

An anode current collector consisting of a lithium layer-coated copper (LiCu) foil (thickness: 20 µm) was arranged on the first anode active material layer, and then attached thereto using cold isotactic pressing (CIP) by applying 250 MPa at 25° C. for 3 minutes, to thereby prepare a laminate of solid electrolyte/anode layer.

### Preparation of Cathode Layer

LiNi_{0.33}Co_{0.33}Mn_{0.33}O₂ (NCM) was prepared as a cathode active material. Carbon black (Cabot) and graphite(SFG6, Timcal) were prepared as conducting agents. A polytetrafluoroethylene (PTFE) binder (Teflon (registered trademark) binder, available from DuPont) was prepared. Then, the materials, i.e., the cathode active material, carbon black, graphite, and the binder were mixed in a mass ratio of 93:3:1:3. The mixture was stretched in the form of a sheet to prepare a cathode active material sheet. This cathode active material sheet was pressed onto a cathode current collector consisting of an aluminum foil having a thickness of 18 um, to thereby form a cathode layer.

The cathode active material layer of the cathode layer was impregnated with a liquid electrolyte in which 2.0 M lithium bis(fluorosulfonyl)imide (LiFSI) was dissolved in N-propyl-N-methyl-pyrrolidinium bis(fluorosulfonyl)imide (PYR13FSl).

### Manufacture Of All-Solid Secondary Battery

A cathode layer was disposed on the solid electrolyte layer of the laminate of the solid electrolyte layer/anode layer, and then sealed with an aluminum pouch under vacuum to thereby manufacture an all-solid secondary battery.

Terminals were connected to the cathode current collector and the anode current collector, respectively, and protruded to the outside of the sealed aluminum pouch to be used as a cathode layer terminal and an anode layer terminal.

### Example 2: Modified Ordered Mesoporous Carbon, Heat-Treated At 300° C. For 6 Hours Preparation Of Modified Ordered Mesoporous Carbon

Modified ordered mesoporous carbon was prepared in the same manner as in Example 1, except that the heat treatment temperature and time were changed to 300° C. and 6 hours.

An all-solid secondary battery was manufactured in the same manner as in Example 1, except that the modified ordered mesoporous carbon prepared above was used.

### Example 3: Modified Ordered Mesoporous Carbon, Heat-Treated at 320° C. For 1 Hour, Containing FeOx (Wherein 0<x<_2)

### Preparation Of Modified Ordered Mesoporous Carbon

0.08 g of iron(II) acetate was dissolved in 5 ml of acetone, and then mixed with 2.9 g of ordered mesoporous carbon (UNIAM Ltd., Korea) to prepare a mixture. The mixture included a precursor in which iron (II) acetate was impregnated in pores of the ordered mesoporous carbon. The mixture was dried at 40° C. for 12 hours, and then dried at 80° C. for 2 hours to prepare dried powder. The dry powder was collected and moved into an alumina crucible.

By heat treatment under an air atmosphere at 320° C. for 1 hour, modified ordered mesoporous carbon supporting 2 wt% of FeOx (wherein 0<x≤2) was prepared.

The amount of iron (Fe) supported on the modified ordered mesoporous carbon was measured using inductively coupled plasma atomic emission spectroscopy (ICP-AES). The amount of the supported iron (Fe) was about 1 wt% with respect to the total weight of the modified ordered mesoporous carbon.

An all-solid secondary battery was manufactured in the same manner as in Example 1, except that the above-prepared modified ordered mesoporous carbon supporting FeOx (wherein 0<x≤2) was used.

The composition of the first anode active material layer consisted of 93 wt% of the modified ordered mesoporous carbon supporting FeOx (wherein 0<x≤2) and 7 wt% of the binder.

As shown in the transmission electron microscope (TEM) images of FIGS. 3A to 3C, it was found that the modified ordered mesoporous carbon prepared in Example 3 was mesoporous carbon having ordered nanochannels having a diameter of about 3 nm.

### Comparative Example 1: Ordered Mesoporous Carbon

An all-solid secondary battery was manufactured in the same manner as in Example 1, except that bare ordered mesoporous carbon (UNIAM Ltd., Korea) was used as it was, instead of the modified ordered mesoporous carbon.

The composition of the first anode active material layer consisted of 93 wt% of the bare ordered mesoporous carbon (bare OMC) and 7 wt% of the binder.

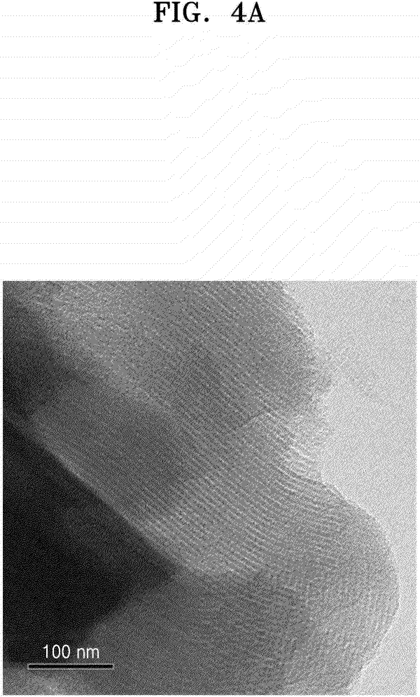

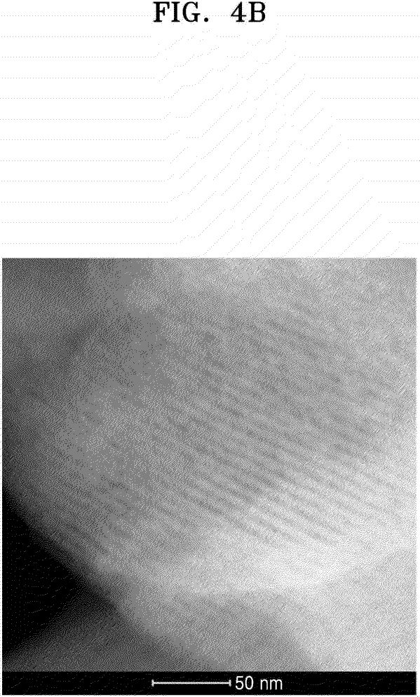

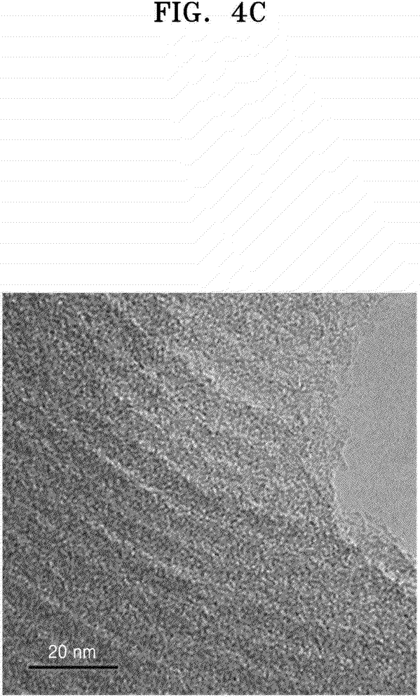

As shown in the TEM images of FIGS. 4A to 4C, it was found that the bare ordered mesoporous carbon prepared in Comparative Example 1 was mesoporous carbon having ordered nanochannels having a diameter of about 3 nm.

### Comparative Example 2: Crystalline Carbon

An all-solid secondary battery was manufactured in the same manner as in Example 1, except that artificial graphite particles (SGF10L, Crystallinity (Lc) >150 nm, Interlayer distance: 0.3354-0.3358 nm, TIMCAL Co.), instead of the modified ordered mesoporous carbon, was used.

The composition of the first anode active material layer consisted of 93 wt% of the artificial graphite particles and 7 wt% of the binder.

### Comparative Example 3: Amorphous Carbon

An all-solid secondary battery was manufactured in the same manner as in Example 1, except that amorphous carbon black (CB-35, Asahi Co.) was used, instead of the modified ordered mesoporous carbon.

The composition of the first anode active material layer consisted of 93 wt% of the amorphous carbon black particles and 7 wt% of the binder.

### Evaluation Example 1: Surface Composition Evaluation

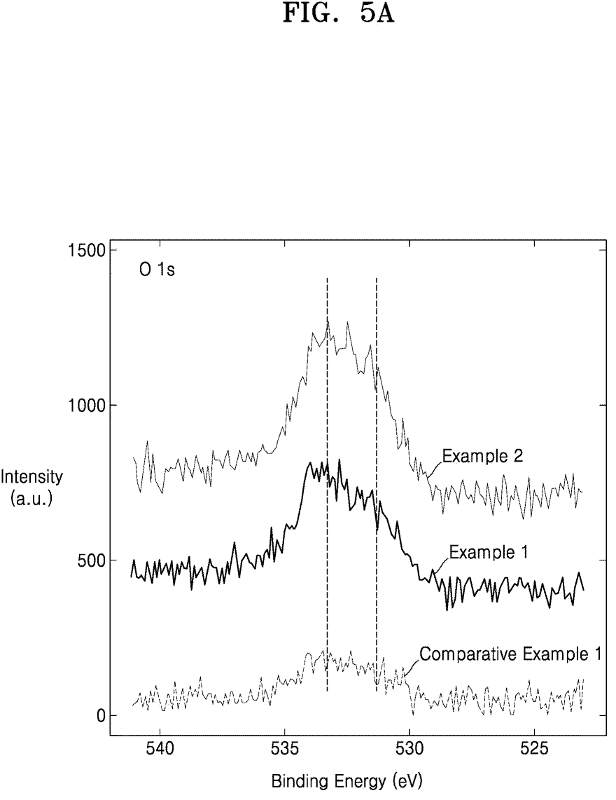

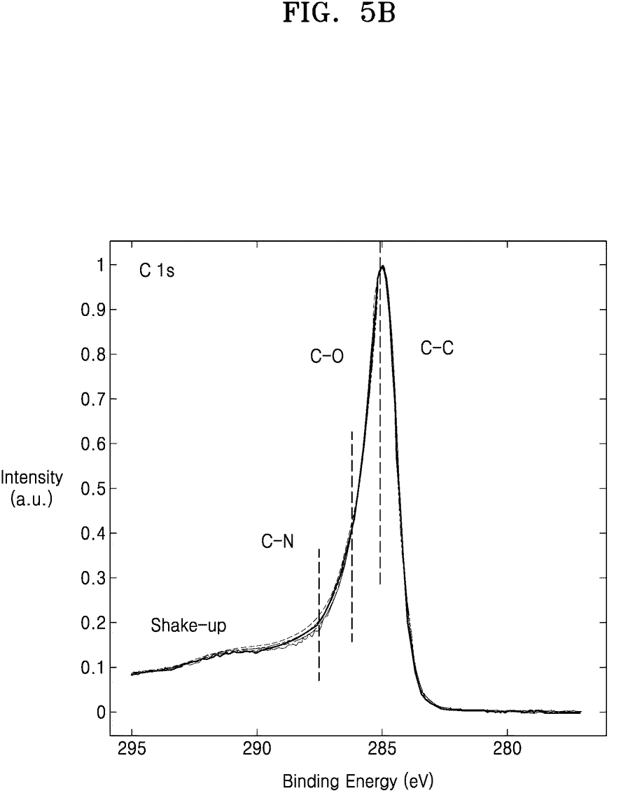

X-ray photoelectron spectroscopy (XPS) spectra of the ordered mesoporous carbons used in Examples 1 and 2 and Comparative Example 1 were measured using a Quantum 2000 (Physical Electronics), and some of the results are shown in FIGS. 5A and 5B.

As shown in FIG. 5A, on the surface of the ordered mesoporous carbon, a peak for organic C═O bonds and a peak for organic C—O bonds were identified at 531.5-532 eV and at about 533 eV, respectively.

Therefore, it was confirmed that oxygen-containing functional groups are present on the surfaces of the modified ordered mesoporous carbons of Examples 1 and 2. The oxygen-containing functional groups may be, for example, a hydroxyl group (—OH), a carboxyl group (—COOH), a carbonyl group (—C(═O)—), or the like.

As shown in FIG. 5B, with respect to the surface of the modified ordered mesoporous carbon of Example 1, peaks for C—N bonds, C—O bonds, and C—C bonds were identified in the range of 285 eV to 290 eV.

The amounts of carbon, nitrogen, and oxygen present on the surface of the ordered mesoporous carbon, in atomic percent based on a total content of the surface, were calculated from the peaks of FIG. 5B, and the results are represented in Table 1.

Table 1

| Example | C1s | N1s | O1s | S2p |
|---|---|---|---|---|
| Comparative Example 1 | 92.06 | 5.25 | 2.14 | 0.55 |
| Example 1 | 88.62 | 5.19 | 5.58 | 0.61 |
| Example 2 | 88 | 6.24 | 5.18 | 0.58 |

As shown in Table 1, the amounts of oxygen arranged on the surfaces of the modified ordered mesoporous carbons of Examples 1 and 2 were significantly higher than the amount of oxygen arranged on the surface of the bare ordered mesoporous carbon of Comparative Example 1.

### Evaluation Example 2: Nitrogen Adsorption Test

Through a nitrogen adsorption test on the carbonaceous material prepared in Examples 1 and 2 and Comparative Examples 1 to 3, Brunauer-Emmett-Teller (BET) specific surface areas, pore volumes, and power diameters were calculated, and the results are represented in Table 2.

Table 2

| Example | BET specific surface area [m²/g] | Pore volume [cm³/g] | Pore diameter [nm] |
|---|---|---|---|
| Comparative Example 1 | 738 | 0.67 | 3.3 |
| Comparative Example 2 | 15 | 0.30 | |
| Comparative Example 3 | 53 | 0.44 | |
| Example 1 | 936 | 0.82 | 3.3 |
| Example 2 | 1048 | 0.90 | 3.3 |

As shown in Table 2, the modified ordered mesoporous carbons of Examples 1 and 2 had larger specific surface areas and larger pore volumes than those of bare ordered mesoporous carbon of Comparative Example 1.

### Evaluation Example 3: X-Ray Diffraction (XRD) Spectrum Evaluation

A small-angle X-ray diffraction (XRD) evaluation was performed on the modified ordered mesoporous carbons of Examples 1 and 2 and the bare ordered mesoporous carbon of Comparative Example 1, and the results are shown in FIG. 6A.

As shown in FIG. 6A, the ordered mesoporous carbons of Examples 1 and 2 and Comparative Example 2 exhibited peaks corresponding to a (100) plane, and thus, were found to have ordered structures.

A wide-angle XRD evaluation was performed on the modified ordered mesoporous carbons of Examples 1 and 2 and the bare ordered mesoporous carbon of Comparative Example 1, and the results are shown in FIG. 6B.

As shown in FIG. 6B, the ordered mesoporous carbons of Examples 1 and 2 and Comparative Example 2 exhibited broad peaks corresponding to (002) plane, and thus, were found to have amorphous structure.

Therefore, it was confirmed that the carbonaceous materials of Examples 1 and 2 and Comparative Example 1 had ordered structures and amorphous structures.

### Evaluation Example 4: Charge-Discharge Test

The charge and discharge characteristics of the all-solid secondary batteries manufactured in Examples 1 to 3 and Comparative Examples 1 and 3 were evaluated according to a charge-discharge test as follows. The charge-discharge test of the all-solid secondary batteries was performed at 25° C.

In a 1st cycle, charging was performed with a constant current of 0.3 mA/cm² until a battery voltage of 4.3 V was reached, and then, charging was performed with the constant voltage until the amount of current was reduced to 1/10. Subsequently, discharging was carried out with a constant current of 0.3 mA/cm² until a battery voltage of 2.85 V was reached.

In the 2nd to 4th cycles, charging was performed with a constant current of 0.5 mA/cm² until a battery voltage of 4.3 V was reached, and then, charging was performed with the constant voltage until the current amount was reduced to 1/10. Subsequently, discharging was carried out with a constant current of 0.5 mA/cm² until a battery voltage of 2.85 V was reached.

In the 5th to 7th cycles, charging was performed with a constant current of 1.0 mA/cm² until a battery voltage of 4.3 V was reached, and then, charging was performed with the constant voltage until the current amount was reduced to 1/10. Subsequently, discharging was carried out with a constant current of 1.0 mA/cm² until a battery voltage of 2.85 V was reached.

In the 8th to 10th cycles, charging was performed with a constant current of 1.6 mA/cm² until a battery voltage of 4.3 V was reached, and then, charging was performed with the constant voltage until the current amount was reduced to 1/10. Subsequently, discharging was carried out with a constant current of 1.6 mA/cm² until a battery voltage of 2.85 V was reached.

In the 11th to 13th cycles, charging was performed with a constant current of 2.0 mA/cm² until a battery voltage of 4.3 V was reached, and then, charging was performed with the constant voltage until the current amount was reduced to 1/10. Subsequently, discharging was carried out with a constant current of 2.0 mA/cm² until a battery voltage of 2.85 V was reached.

In the 14th to 50th cycles, charging was performed with a constant current of 1.6 mA/cm² until a battery voltage of 4.3 V was reached, and then, charging was performed with the constant voltage until the current amount was reduced to 1/10. Subsequently, discharging was carried out with a constant current of 1.6 mA/cm² until a battery voltage of 2.85 V was reached.

A rest period of 10 minutes was allowed after each charging-discharging step.

Some of the charge-discharge tests are represented in Tables 3 and 4.

In Table 3, 1.0 mA/cm²/0.5 mA/cm² is a ratio of the average discharge capacity at the 5th to 7th cycles of charging and discharging with a constant current of 1.0 mA/cm² to the average discharge capacity at the 2nd to 4th cycles of charging and discharging with a constant current of 0.5 mA/cm².

In Table 3, 2.0 mA/cm²/0.5 mA/cm² is a ratio of the average discharge capacity at the 11th to 13th cycles of charging and discharging with a constant current of 2.0 mA/cm² to the average discharge capacity at the 2nd to 4th cycles of charging and discharging with a constant current of 0.5 mA/cm².

In Table 4, the discharge capacity is a discharge capacity at the 36th cycle.

Table 3

| | Average discharge capacity at 5th to 7th cycles/ Average discharge capacity at 2nd to 4th cycles (1.0 mA/cm²/ 0.5 mA/cm²) | Average discharge capacity at 11th to 13th cycles/ Average discharge capacity at 2nd to 4th cycles (2.0 mA/cm²/ 0.5 mA/cm²) |
|---|---|---|
| Comparative Example 1 | 0.77 | 0.48 |
| Comparative Example 2 | 0.80 | 0.57 |
| Comparative Example 3 | 0.89 | 0.62 |
| Example 1 | 0.96 | 0.74 |
| Example 2 | 0.91 | 0.68 |

As shown in Table 3, the all-solid secondary batteries of Examples 1 and 2 had improved high-rate characteristics, compared to the all-solid secondary batteries of Comparative Examples 1 to 3.

Table 4

| | Discharge capacity at 36th cycle [mAh/cm²] |
|---|---|
| Comparative Example 1 | 1.44 |
| Comparative Example 2 | Short-circuit (31st cycle) |
| Comparative Example 3 | 2.09 |
| Example 1 | 2.61 |
| Example 2 | 2.48 |
| Example 3 | 2.64 |

The all-solid secondary batteries of Examples 1 to 3 and Comparative Examples 1 to 3 had a discharge capacity of about 3.3 mAh/cm² at the 1st cycle.

As shown in Table 4, the all-solid secondary batteries of Examples 1 to 3 exhibited improved discharge capacities and lifespan characteristics, compared to the all-solid secondary batteries of Comparative Examples 1 to 3.

As described above, the all-solid secondary battery according to any of the above-described embodiments may be applied to various portable devices or vehicles.

According to the one or more embodiments, an all-solid secondary battery having increased discharge capacity, and improved high-rate characteristics and lifetime characteristics may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An all-solid secondary battery comprising:
a cathode layer;
an anode layer; and
a solid electrolyte layer between the cathode layer and the anode layer, wherein
the anode layer comprises an anode current collector and a first anode active material layer on the anode current collector,
the first anode active material layer comprises a modified ordered mesoporous carbon, and
an oxygen content of a surface of the modified ordered mesoporous carbon is about 3 atomic percent to about 10 atomic percent, based on a total content of the surface, when determined by X-ray photoelectron spectroscopy of a surface of the modified ordered mesoporous carbon.

2. The all-solid secondary battery of claim 1,
wherein the modified ordered mesoporous carbon has an amorphous structure.

3. The all-solid secondary battery of claim 1,
wherein the modified ordered mesoporous carbon has a particle size of about 50 nanometers to about 2 micrometers, and
a pore having a pore size of about 2 nanometers to about 20 nanometers.

4. The all-solid secondary battery of claim 1,
wherein the modified ordered mesoporous carbon has a specific surface area of about 600 square meters per gram to about 1500 square meters per gram, and
the modified ordered mesoporous carbon has a pore volume of about 0.6 cubic centimeters per gram to about 2 cubic centimeters per gram.

5. The all-solid secondary battery of claim 1,
wherein the first anode active material layer further comprises a first metal oxide, a first metal, or a combination thereof, and
the first metal oxide, the first metal, or a combination thereof is disposed on the modified ordered mesoporous carbon.

6. The all-solid secondary battery of claim 5,
wherein the first metal oxide has an amorphous structure, and the first metal oxide has a particle size of about 1 nanometer to about 1 micrometer.

7. The all-solid secondary battery of claim 5,
wherein the first metal oxide comprises FeOₓ, wherein 0<x≤2, AlOₓ, wherein 0<x≤2, SnOₓ, wherein 0<x≤2, GeOₓ, wherein 0<x≤2, SiOₓ, wherein 0<x≤2, ScOₓ, wherein 0<x≤2, CrOₓ, wherein 0<x≤5, MnOₓ, wherein 0<x≤3, CoOₓ, wherein 0<x≤2, NiOₓ, wherein 0<x≤2, CuOₓ, wherein 0<x≤2, or a combination thereof.

8. The all-solid secondary battery of claim 5,
wherein the first metal oxide comprises FeO, FeO₂, Fe₂O₃, Fe₃O₄, Al₂O₃, SnO, GeO, SiO, SiO₂, Sc₂O₃, CrO, Cr₂O₃, CrO₂, CrO₃, CrO₅, MnO, Mn₂O₃, Mn₃O₄, MnO₂, MnO₃, CoO, Co₂O₃, Co₃O₄, NiO, Ni₂O₃, CuO, CuO₂, Cu₂O₃, Cu₂O, or a combination thereof.

9. The all-solid secondary battery of claim 5,
wherein the first metal comprises Fe, Al, Sn, Ge, Si, Sc, Cr, Mn, Co, Ni, Cu, or a combination thereof, and the first metal oxide comprises an oxide of the first metal.

10. The all-solid secondary battery of claim 5,
wherein the first metal, the first metal oxide, or a combination thereof is contained in an amount of about 0.1 weight percent to about 5 weight percent, based on a total weight of the modified ordered mesoporous carbon, when analyzed by inductively coupled plasma analysis.

11. The all-solid secondary battery of claim 1,
wherein the first anode active material layer further comprises a second metal, a second metal oxide, or a combination thereof.

12. The all-solid secondary battery of claim 11,
wherein the second metal is a metal anode active material, and
the metal anode active material comprise silver, tin, germanium, indium, silicon, gallium, aluminum, titanium, zirconium, niobium, antimony, bismuth, gold, platinum, palladium, magnesium, zinc, an alloy thereof, or a combination thereof.

13. The all-solid secondary battery of claim 1,
wherein an amount of the modified ordered mesoporous carbon is about 90 weight percent to about 99 weight percent, with respect to a total weight of the first anode active material layer.

14. The all-solid secondary battery of claim 1,
wherein the first anode active material layer further comprises a binder.

15. The all-solid secondary battery of claim 1,
wherein the cathode layer comprises a cathode active material layer, and a ratio of a charge capacity of the first anode active material layer to a charge capacity of the cathode active material layer satisfies Expression 1:
$$0.01 < \text{b/a} < 1$$
wherein in Expression 1, a is a charge capacity of the cathode active material layer, and b is a charge capacity of the first anode active material layer.

16. The all-solid secondary battery of claim 1, further comprising a second anode active material layer arranged between the first anode active material layer and the anode current collector,
wherein the second anode active material layer is a lithium layer, a lithium-alloyable metal layer, or a combination thereof, and
the second anode active material layer comprises lithium metal or a lithium alloy.

17. The all-solid secondary battery of claim 1,
wherein the solid electrolyte layer comprises an oxide solid electrolyte, a sulfide solid electrolyte, a polymer solid electrolyte, or a combination thereof.

18. The all-solid secondary battery of claim 17,
wherein the oxide solid electrolyte comprises Li_{1+x+y}AlₓTi₂₋ₓSi_{y}P_{3-y}O₁₂, wherein 0<x<2 and 0≤y<3, BaTiO₃, PbZrₓTi₁₋ₓ)O₃ wherein 0≤x≤1, Pb₁₋ₓLaₓZr_{1-y} Ti_{y}O₃, wherein 0≤x<1, and 0≤y<1, Pb(Mg_{⅓}Nb_{⅔})O₃-PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃, wherein 0<x<2 and 0<y<3, LiₓAl_{y}Ti_{z}(PO₄)₃. wherein 0<x<2, 0<y<1, and 0<z<3, Li_{1+x+y}(AlₐGa₁₋ₐ)ₓ(Ti_{b}Ge₁₋ _{b})₂₋ₓSi_{y}P_{3-y}O₁₂, wherein 0≤x≤1, 0≤y≤1, 0≤a≤1, and 0≤b≤1, LiₓLa_{y}TiO₃, wherein 0<x<2 and 0<y<3, Li₂O, LiOH, Li₂CO₃, LiAlO₂, Li₂O-Al₂O₃-SiO₂-P₂O₆-TiO₂-GeO₂, Li₃₊ₓLa₃M₂O₁₂, wherein M is Te, Nb, Zr, or a combination thereof, and 0≤x≤10, Li₃₊ₓLa₃Zr_{2-y}M_{y}O₁₂, wherein M is Ga, W, Nb, Ta, Al, or a combination thereof, 0≤x≤10, and 0<y<2, Li₇La₃Zr₂₋ ₓTaₓO₁₂, wherein 0<x<2, or a combination thereof.

19. The all-solid secondary battery of claim 17,
wherein the oxide solid electrolyte comprises Li₇La₃Zr₂O₁₂, Li_{6.5}La₃Zf₁₅Ta_{0.5}O₁₂, Li_{1.3}Al_{0.3}Ti_{1.7}(PO₄)₃, Li_{0.34}La_{0.51}TiO_{2.94}, Li_{1.07}Al_{0.69}Ti_{1.46}(PO₄)₃, 50Li₄SiO₄-50Li₂BO₃, 90Li₃BO₃-10Li₂SO₄, Li_{2.9}PO_{3.3}N_{0.46}, or a combination thereof.

20. The all-solid secondary battery of claim 17,
wherein the sulfide solid electrolyte comprises Li₂S-P₂S₅, Li₂S-P₂S₅-LiX, wherein X is a halogen, Li₂S-P₂S₅-Li₂O, Li₂S-P₂S₅-Li2_{O}-Lil, Li₂S-SiS₂, Li₂S-SiS₂-Lil, Li₂S-SiS₂-LiBr, Li₂S-SiS₂-LiCl, Li₂S-SiS₂-B₂S₃-Lil, Li₂S-SiS₂-P₂S₅-Lil, Li₂S-B₂S₃, Li₂S-P₂S₅-ZₘSₙ, wherein m and n are each independently a positive number, and Z is Ge, Zn, Ga, or a combination thereof, Li₂S-GeS₂, Li₂S-SiS₂-LiₚMO_{q}, wherein p and q are each independently a positive number, and M is P, Si, Ge, B, Al, Ga, or In, Li₂S-SiS₂-Li₃PO₄, or a combination thereof.

21. The all-solid secondary battery of claim 17,
wherein the sulfide solid electrolyte is an argyrodite-type solid electrolyte represented by Formula 1:
$${\text{Li}}^{+} {}_{12 - \text{n-x}} {\text{A}}^{\text{n} +} {\text{X}}^{2 -} {}_{\text{6-x}} {\text{Z}}^{\text{-}} {}_{\text{x}}$$
wherein, in Formula 1,
A is P, As, Ge, Ga, Sb, Si, Sn, Al, In, Ti, V, Nb, or Ta,
X is S, Se, Te, or a combination thereof,
Z is Cl, Br, I, F, CN, OCN, SCN, N₃, or a combination thereof,
1≤n≤5, and 0≤x≤2.

22. The all-solid secondary battery of claim 1,
wherein the solid electrolyte layer comprises a liquid-impermeable ion-conductive composite membrane, and
the liquid-impermeable ion-conductive composite membrane comprises an oxide solid electrolyte, a composite of the oxide solid electrolyte and an ion-conductive polymer, or a combination thereof.

23. The all-solid secondary battery of claim 1,
wherein the cathode layer comprises a cathode active material layer,
the cathode active material layer comprises a solid electrolyte, a liquid electrolyte, or a combination thereof,
the solid electrolyte comprises an oxide solid electrolyte, a sulfide solid electrolyte, a polymer solid electrolyte, or a combination thereof,
the liquid electrolyte comprises an ionic liquid, a lithium salt, or a combination thereof, and
the liquid electrolyte is absent from the anode layer and the solid electrolyte layer.

24. A method of manufacturing an all-solid secondary battery, the method comprising:
providing an ordered mesoporous carbon optionally comprising a precursor of a first metal oxide, a precursor of a first metalloid oxide, or a combination thereof;
thermally treating the ordered mesoporous carbon in an oxidizing atmosphere to prepare a modified ordered mesoporous carbon;
disposing the modified ordered mesoporous carbon in the form of a layer to prepare an anode layer; and
stacking a solid electrolyte between the anode layer and a cathode layer,
wherein an oxygen content of a surface of the modified ordered mesoporous carbon is about 3 atomic percent to about 10 atomic percent, based on a total content of the surface, when determined by X-ray photoelectron spectroscopy of the surface of the modified ordered mesoporous carbon.

25. The method of claim 24,
wherein the thermal treating is performed at a temperature of about 250° C. to about 400° C. for a time period of about 1 hour to about 10 hours.
